(19) United States
(12) Patent Application Publication
(10) Pub. No.: US 2024/0173914 A1
(43) Pub. Date: May 30, 2024

(54) HIGH-VISCOSITY RESINS IN MASK PROJECTION STEREOLITHOGRAPHY

(71) Applicant: VIRGINIA TECH INTELLECTUAL PROPERTIES, INC., Blacksburg, VA (US)

(72) Inventors: Daniel A. RAU, Blacksburg, VA (US); Christopher B. WILLIAMS, Blacksburg, VA (US)

(21) Appl. No.: 18/550,847

(22) PCT Filed: Mar. 17, 2022
(86) PCT No.: PCT/US2022/071196

§ 371 Date: Sep. 15, 2023

Related U.S. Application Data
(60) Provisional application No. 63/162,269, filed on Mar. 17, 2021.

(51) Int. Cl. B29C 64/129; B29C 64/209; B29C 64/286; B29C 64/393; B33Y 10/00; B33Y 30/00; B33Y 50/02; B33Y 70/00

(52) U.S. Cl. CPC B29C 64/129; B29C 64/209; B29C 64/286; B29C 64/393; B33Y 10/00; B33Y 30/00; B33Y 50/02; B33Y 70/00

(57) ABSTRACT

A method for fabricating an item using a high-viscosity photoresin is described that includes providing tooling that comprises an extruder and a light source: depositing. by the extruder of the tooling. a first non-patterned layer of the high-viscosity photoresin: selectively photocuring. by the light source of the tooling. the first non-patterned layer into a first predetermined layer shape: depositing. by the extruder of the tooling. a second nonpatterned layer of the high-viscosity photoresin: and selectively photocuring. by the light source of the tooling. the second non-patterned layer into a second predetermined layer shape.

### CROSS-REFERENCE TO RELATED APPLICATION

This application claims the benefit of and priority to U.S. Provisional Patent Application No. 63/162,269 filed Mar. 17, 2021, entitled “METHOD TO USE HIGH-VISCOSITY RESINS IN MASK PROJECTION STEREOLITHOGRAPHY,” the contents of which being incorporated by reference in their entirety herein.

### TECHNICAL FIELD

The present disclosure relates to three-dimensional printing and, more specifically, to forming items using high-viscosity resins to product items having improved characteristics.

### BACKGROUND

Direct Ink Writing (DIW) is a type of material extrusion additive manufacturing. In DIW, material is selectively deposited by translating an extrusion nozzle to create the desired shape of a part. Material is extruded through the nozzle by applying either a pneumatic or mechanical force. Mask Projection Stereolithography (MPSL) is another additive manufacturing technology where ultraviolet (UV) light is used to cure a layer of liquid photopolymer.

### BRIEF SUMMARY

Various embodiments for high-viscosity resins in mask projection stereolithography are described. In a first aspect, a method for fabricating an item using a high-viscosity photoresin is described that includes providing tooling that comprises an extruder and a light source; depositing, by the extruder of the tooling, a first non-patterned layer of the high-viscosity photoresin; selectively photocuring, by the light source of the tooling, the first non-patterned layer into a first predetermined layer shape; depositing, by the extruder of the tooling, a second non-patterned layer of the high-viscosity photoresin; and selectively photocuring, by the light source of the tooling, the second non-patterned layer into a second predetermined layer shape.

Selectively photocuring the first non-patterned layer may include: depositing the high-viscosity photoresin to form a bounding box, and photocuring the high-viscosity photoresin of the bounding box to create a vat having a cured border and having uncured material within the cured boarder; and depositing an additional amount of the high-viscosity photoresin within the cured border and selectively curing the additional amount of the high-viscosity photoresin using an applied dynamic mask of the light source. The bounding box may be sized larger than a desired part such that a spacing of approximately 1 mm existing between the desired part and the bounding box.

In some embodiments, the extruder is one of a plurality of extruders; and the high-viscosity photoresin is one of a plurality of high-viscosity photoresins, wherein the bounding box is formed of a first type of the plurality of high-viscosity photoresins and the additional amount of the high-viscosity photoresin is a second type of the plurality of high-viscosity photoresins, the first type and the second type being different from one another.

In some embodiments, after the additional amount of the high-viscosity photoresin is deposited within the cured border, and prior to the selectively curing of the additional amount, the method further includes pausing to allow the additional amount of uncured extruded photoresin to coalesce, permit a layer height of the first non-patterned layer to become even, and reduce non-homogeneity of discrete beads. In some embodiments, the method includes identifying a current layer of the item to be formed; and adjusting a dynamic mask of the light source using an image associated with the current layer, wherein selectively photocuring the viscosity photoresin using the dynamic mask as adjusted.

Depositing the additional amount of the high-viscosity photoresin within the cured border may include performing, by the extruder, multiple parallel horizontal extrusions, wherein, when the extruder reaches an end of a respective one of the horizontal extrusions, the depositing of the additional amount of the high-viscosity photoresin is stilled while the extruder continues to translate in a same direction until the extruder moves past the bounding box, thereby producing a homogenous infill. The method may further include adjusting a flow rate from a nozzle of the extruder to match a translation speed of the extruder and a layer height.

In further embodiments, the method may include generating a plurality of black-and-white image files, each of the black-and-white image files corresponding to a layer of the item to be fabricated using the high-viscosity resin; and directing the light source to project one of the black-and-white image files according to a current one of the layers being formed. The high-viscosity photoresin may be one of an all-aromatic polyimide, a urethane acrylate elastomer, and an alumina photopolymer suspension.

In a second aspect, a system for fabricating an item using a high-viscosity photoresin is described that includes a tool head comprising an extruder and a light source; and program instructions stored in memory and executable by at least one hardware processor that, when executed, direct the at least one hardware processor to: deposit, by the extruder of the tooling, a first non-patterned layer of the high-viscosity photoresin; selectively photocure, by the light source of the tooling, the first non-patterned layer into a first predetermined layer shape; deposit, by the extruder of the tooling, a second non-patterned layer of the high-viscosity photoresin; and selectively photocure, by the light source of the tooling, the second non-patterned layer into a second predetermined layer shape.

Selectively photocuring the first non-patterned layer may include depositing the high-viscosity photoresin to form a bounding box, and photocuring the high-viscosity photoresin of the bounding box to create a vat having a cured border and having uncured material within the cured boarder; and depositing an additional amount of the high-viscosity photoresin within the cured border and selectively curing the additional amount of the high-viscosity photoresin using an applied dynamic mask of the light source. The bounding box may be sized larger than a desired part such that a spacing of approximately 1 mm existing between the desired part and the bounding box.

In some embodiments, the extruder is one of a plurality of extruders; the high-viscosity photoresin is one of a plurality of high-viscosity photoresins; and the bounding box is formed of a first type of the plurality of high-viscosity photoresins and the additional amount of the high-viscosity photoresin is a second type of the plurality of high-viscosity photoresins, the first type and the second type being different from one another.

In some embodiments, after the additional amount of the high-viscosity photoresin is deposited within the cured border, and prior to the selectively curing of the additional amount, the at least one hardware processor is further directed to wait to allow the additional amount of uncured extruded photoresin to coalesce, permit a layer height of the first non-patterned layer to become even, and reduce non-homogeneity of discrete beads.

The at least one hardware processor may be further directed to: identify a current layer of the item to be formed; and adjust a dynamic mask of the light source using an image associated with the current layer, wherein selectively photocuring the viscosity photoresin using the dynamic mask as adjusted.

Depositing the additional amount of the high-viscosity photoresin within the cured border may include performing, by the extruder, multiple parallel horizontal extrusions, wherein, when the extruder reaches an end of a respective one of the horizontal extrusions, the depositing of the additional amount of the high-viscosity photoresin is stilled while the extruder continues to translate in a same direction until the extruder moves past the bounding box, thereby producing a homogenous infill.

The at least one hardware processor may be further directed to adjust a flow rate from a nozzle of the extruder to match a translation speed of the extruder and a layer height. Additionally, the at least one hardware processor may be further directed to generate a plurality of black-and-white image files, each of the black-and-white image files corresponding to a layer of the item to be fabricated using the high-viscosity resin; and direct the light source to project one of the black-and-white image files according to a current one of the layers being formed. The high-viscosity photoresin may be one of an all-aromatic polyimide, a urethane acrylate elastomer, and an alumina photopolymer suspension.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1A is a top-down vat photopolymerization system in the related art.

FIG. 1B is a bottom-up vat photopolymerization system in the related art.

FIG. 2 is a direct ink write (DIR) process to extrude material in the related art.

FIG. 3 is a schematic diagram illustrating an example process for depositing and curing material in accordance with various embodiments of the present disclosure.

FIG. 4 is a schematic diagram illustrating an example system for implementing the process of FIG. 3 for depositing and curing material in accordance with various embodiments of the present disclosure.

FIG. 5 is a post-processing sequence employed after the depositing and curing of material in accordance with various embodiments of the present disclosure.

FIG. 6A is a scheme showing conversion of UV-curable PAA photoresin to final PMDA-ODA PI art with thermal treatment after printing in accordance with various embodiments of the present disclosure.

FIG. 6B is a thermal treatment process used after 24 h air dry to remove solvent, pyrolize crosslinks, and imidize the PAA into a final all-aromatic polyimide in accordance with various embodiments of the present disclosure.

FIG. 7A is a plot of viscosity versus shear rate of PAA photoresin demonstrated its high zero-shear rate viscosity (770 Pa s) and shear thinning behavior in accordance with various embodiments of the present disclosure.

FIG. 7B is a working curve that relates an amount of UV irradiation exposure

to a resulting cured thickness of the PAA photoresin in accordance with various embodiments of the present disclosure.

FIG. 8A is a printed PAA organo-gel after printing and all-aromatic polyimide counterparts following thermal post-processing in accordance with various embodiments of the present disclosure.

FIG. 8B is an uncured highly-viscous photoresin providing support for large overhanging structures (e.g., 22 mm long) without the need for cured support structures in accordance with various embodiments of the present disclosure.

FIG. 8C is a thermogravimetric analysis showing five percent degradation temperature of an all-aromatic polyimide to be 534° C. in accordance with various embodiments of the present disclosure.

FIG. 8D is DMA showing that the all-aromatic polyimide material has a storage modulus remaining above 1 GPa up to 400° C. in accordance with various embodiments of the present disclosure.

FIG. 9A shows viscosity versus shear rate of the neat and 5 wt % silica containing photoresin in accordance with various embodiments of the present disclosure where the neat photoresin and 5 wt % silica containing photoresin demonstrated zero-shear rate viscosities of 21.7 Pa s and 38.6 Pa s respectively.

FIG. 9B shows a working curve relating to the amount of UV irradiation exposure to the resulting cured thickness of the photoresin in accordance with various embodiments of the present disclosure.

FIG. 10A shows three-dimensionally printed parts from neat urethane acrylate resin in accordance with various embodiments of the present disclosure.

FIG. 10B shows three-dimensionally printed parts from urethane acrylate with 5 wt % silica photoresin in accordance with various embodiments of the present disclosure.

FIG. 10C shows tensile tests of the printed urethane acrylate specimens demonstrating excellent elongation at break and strength in accordance with various embodiments of the present disclosure.

FIG. 11A shows viscosity and shear stress versus shear rate of the photoresin, where a zero-shear rate viscosity of 1350 Pa s and shear thinning behavior was demonstrated in accordance with various embodiments of the present disclosure.

FIG. 11B shows a working curve of the ceramic suspensions relates exposure to the cure depth for the material in accordance with various embodiments of the present disclosure.

FIG. 12A shows a printed green body and parts after sintering in accordance with various embodiments of the present disclosure.

FIG. 12B shows a SEM image of green body cross section shows no evidence of layer lines or extrusion beads in accordance with various embodiments of the present disclosure.

FIG. 12C shows a SEM image of sintered part cross section shows sintering, with a degree of porosity in accordance with various embodiments of the present disclosure.

FIG. 12D shows a three-point flexural test of printed and sintered alumina specimens at 25 and 400° C. demonstrated an average flexural strength of 154.9 and 156.6 MPa respectively in accordance with various embodiments of the present disclosure.

FIG. 13A shows negative feature size resolution part printed from the 85 wt % alumina photoresin showed ability to successful pattern features as small as 0.5 mm in accordance with various embodiments of the present disclosure.

FIG. 13B shows positive feature size resolution part printed from the 85 wt % alumina photoresin showed ability to successful pattern features as small as 0.25 mm in accordance with various embodiments of the present disclosure.

FIG. 13C shows both the positive and negative feature size parts printed from the 85 wt % alumina photoresin showed good agreement with the desired feature size in accordance with various embodiments of the present disclosure where, at larger widths, the measured width was greater than the designed width due to small projector calibration errors.

FIG. 14A shows negative feature size resolution part printed from the urethane acrylate with 5 wt % silica photoresin showed ability to successful pattern features as small as 0.5 mm in accordance with various embodiments of the present disclosure.

FIG. 14B shows positive feature size resolution part printed from the urethane acrylate with 5 wt % silica photoresin showed ability to successful pattern features as small as 0.25 mm in accordance with various embodiments of the present disclosure.

FIG. 14C shows both the positive and negative feature size parts printed from the urethane acrylate with 5 wt % silica photoresin showed good agreement with the desired feature size in accordance with various embodiments of the present disclosure, where, at larger widths, the actual width was greater than the expected width due to slight projector calibration errors.

FIGS. 15A and 15B show a comparison of PAA photoresin parts printed using the hybrid VP/DIW process (FIG. 15A) and a traditional UV-DIW process (FIG. 15B) with a dime for scale in accordance with various embodiments of the present disclosure.

FIG. 16 is a flowchart illustrating an example of a three-dimensional printing process for using high-viscosity resins.

FIG. 17 is a schematic diagram illustrating an example of a three-dimensional printing process for using high-viscosity resins.

### DETAILED DESCRIPTION

The present disclosure relates to use of high-viscosity resins in mask projection stereolithography. Vat Photopolymerization (VP) is an additive manufacturing (AM) process that enables fabrication of parts with features having a high-resolution and sharp corners through selective patterning of UV irradiation. Currently, VP is capable of only processing low-viscosity photoresins due to constraints imposed by a recoating process, which limits both the available materials and the mechanical properties of the final parts. Conversely, Direct Ink Write (DIW), a material extrusion process, is capable of processing high-viscosity photoresins, but patterns features directly via a nozzle, which limits both achievable feature resolution and shape.

To enable a layered processing of high-viscosity photoresins and thus utilize high-performance materials while manufacturing items with high-resolution features, various embodiments are described herein for an additive manufacturing process that integrates DIW and VP printing modalities. The additive manufacturing process uses a DIW system to extrude an un-patterned layer of photoresin that is then selectively photocured into a desired layer shape by a light source, such as an ultraviolet (UV) digital light processing (DLP) projector. The pressurized extrusion mechanism of DIW and shear-thinning behavior of the photoresins enable processing of photoresins with viscosities that are multiple orders of magnitude larger than which can be currently processed via traditional VP. A selective irradiation of the dispensed layer enables the realization of high-resolution features that are orders of magnitude smaller than that which can be currently processed via DIW. A relaxation of viscosity constraints allows printing of new photoresins with novel chemistries, high molecular weight monomers, and/or high solids loading that ultimately result in greatly improved material properties compared to traditional photoresins.

To demonstrate the capabilities of the system and methods described herein, three materials were printed from high-viscosity photoresins, namely, an all-aromatic polyimide, a urethane acrylate elastomer, and a highly-loaded alumina photopolymer suspension. The all-aromatic polyimide photoresin had a viscosity of 770 Pa·s and the final parts had a degradation temperature of 534° C. The urethane acrylate elastomer photoresin had a viscosity of 21.7 Pa·s and the parts exhibited an average elongation of 599% and an average stress of 16.3 MPa at failure. A stiffer reinforced urethane acrylate photoresin with 5 wt % silica had a viscosity of 38.6 Pa·s. The parts exhibited an average elongation of 430% and an average stress of 14.8 MPa at failure. The 85 wt % alumina photopolymer suspension had a viscosity of 1350 Pa·s, exhibiting a final sintered flexural strength at 25 and 400° C. of 154.9 and 156.6 MPa, respectively. These three case studies demonstrate the ability to print high-performance materials from high-viscosity photoresins while retaining high-resolution and sharp features expected of three-dimensionally-printed parts in accordance with the various embodiments described herein.

Notably, vat photopolymerization builds parts from a three-dimensional computer-aided design model (e.g., a CAD file) by selectively photocuring photoresin in a layer-by-layer fashion. VP excels at printing high-resolution features with sharp corners due to its selective patterning of UV irradiation onto a liquid resin vat. Additionally, VP offers a superior surface finish due to the curing of a liquid resin and its small layer size, which minimizes stair stepping effects.

Current downsides of VP is its limited quantity and quality of materials. As such, use of high-performance polymers, elastomers, and ceramics are of specific interest. Historically, VP has been limited in its ability to process these classes of materials as current systems are constrained to photoresins that have low viscosities (>10 Pa·s) due to their layer recoating mechanisms. To achieve the low viscosities necessary for VP AM, most photoresins employ low molecular weight monomers and reactive diluents, which results in glassy, rigid, and brittle materials. While some researchers have investigated loading VP resins with solid particles (e.g., ceramics), the viscosity constraint limits the solids loading percentage of the resultant colloid, thereby causing printed parts to incur large shrinkage during thermal post-processing, and often resulting in a poor final density. As such, increasing the processable photoresin viscosity range for VP is of key interest, as it would enable printing of only high-performance polymers, elastomers, ceramics, and other materials.

Mask-Projection VP (MP-VP) systems utilize a dynamic mask generator, such as a Digital Micromirror Device (DMD) or Liquid Crystal Display (LCD), to pattern UV irradiation in the shape of each layer. In other systems, a laser is responsible for scanning the shape of each the layer to provide selective curing. Both methods routinely use focusing optics to reduce the size of the patterned light which enables the creation of high resolution parts with feature sizes on the order of 10 μm. The UV-induced crosslinking of the resin produces parts that can exhibit nearly isotropic mechanical properties with post-curing.

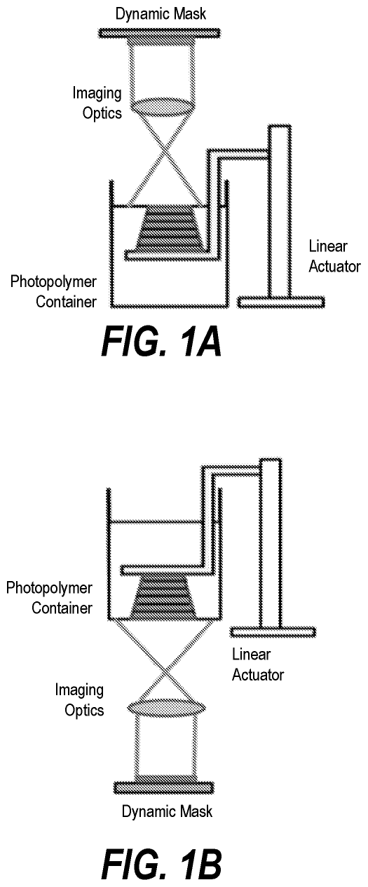

VP systems includes “top-down” and “bottom-up” systems. In Top-Down VP systems, a build platform is lowered into a vat of photoresin while UV irradiation is patterned from above. As shown in FIG. 1A, the UV irradiation selectively cures the surface of the vat, and the linear actuator moves down for the next layer of uncured photoresin to be recoated and then selectively cured, repeating the process multiple times. As shown in FIG. 1B, Bottom-Up systems use a thin layer of liquid photoresin between a transparent window and the part. Patterned UV irradiation passes through the window, curing the part from below. The linear actuator (e.g., an elevator) moves up allowing the next layer of non-cured photoresin to be recoated between the part and the window and then cured.

A significant difference between Top-Down and Bottom-Up systems is the methods used for recoating the uncured layer of photoresin. For successful printing, it is desirable that the recoated layer is flat, homogenous, and has a controlled thickness. A layer that is too thick may not be cured deep enough to fully bond to the previous layer, leading to poor part strength or a failed print. A layer that is too thin will be over-cured into the previous layer, leading to a dimensionally inaccurate part. Not only does the layer thickness need to be controlled, it also should be flat and homogenous, or the resulting part will again suffer dimensional inaccuracies and reduced quality. Independent of the printing system or recoating method used, these requirements currently impose a limitation of printing only low-viscosity photoresins.

Recoating in Top-Down systems can be accomplished by “dipping” the part down into the liquid photoresin vat after layer curing is complete. The photoresin is allowed to flow over top the part, then the part is raised up to just below the liquid surface for the next layer curing to begin. However, a surface tension of the resin can prohibit dipping from producing flat and consistent layers due to meniscus formation and requires long waiting periods for excess photoresin to spread and level. As a result, a blade is often used to spread the liquid surface, producing a flat layer in less time. This blade-based recoating method has taken many forms and variations, including an active blade that deposits and scrapes material to improve speed and reliability. Another methodology, the Zephyr blade, referred to as a U-blade, holds resin in a reservoir under vacuum in an inverted U-shape above the part. As the U-blade is moved across the surface of the vat, resin is added to unfilled areas and excess resin is removed through the combination of capillary and electrostatic forces.

As such, a majority of the various recoating systems are blade-based systems or “contactful” systems due to their physical interaction with the vat of photoresin. Recoating using a blade-based system is achieved by the shear stress induced by the blade moving across the liquid photoresin. The induced shear stress increases proportionally with viscosity. Therefore, blade-based recoating systems are generally limited to lower viscosity photoresins. It has been reported that scraping and other recoating methods have been limited to photoresin less than 5-15 Pa·s. To enable VP of highly-filled photopolymer resins, other systems employ a recoating system that uses a blade to spread resin across a build piston. It is noted that the excessive shear stress imposed on the built part from contactful recoating of viscous resins can cause deformation and/or print failure. In addition, the time required to recoat a new layer with these techniques increases with increased resin viscosity.

The constrained surface provided by the transparent window/membrane found in Bottom-Up VP systems may ensure a homogenous layer of photoresin. To cure subsequent layers, these systems rely on gravity-induced flow of the resin, often coupled with a variety of mechanical motions (e.g., wiper blades, peeling and sliding motions of the build tray, and the like) to decrease the time delay between printed layers. To ensure the photoresin flows adequately beneath the window and the part, and to ensure minimal stress is induced on the built part, low-viscosity photoresins are again required. With the addition of a recoating blade, a bottom-up system has demonstrated printing a photoresin with a maximum viscosity of 20 Pa·s.

Some systems propose a printing of high-viscosity resins (5-250 Pa·s) using a blade-based tape-casting recoating approach and bottom-up printing. Because bottom-up printing is used, the part is not subjected to shear stresses induced by the recoating blade. However, special care must be given so that the part does not break when being detached from the transparent window/membrane.

Heating the resin vat has been used as another strategy to lower a viscosity of a photoresin into a processable range. While success-fully demonstrated, these approaches are limited to photoresins that demonstrate a decreased viscosity with an increase in temperature to a printable range before the onset of thermal crosslinking. Additionally, resins containing solvent and other liquids that evaporate during heating are not printable on such systems.

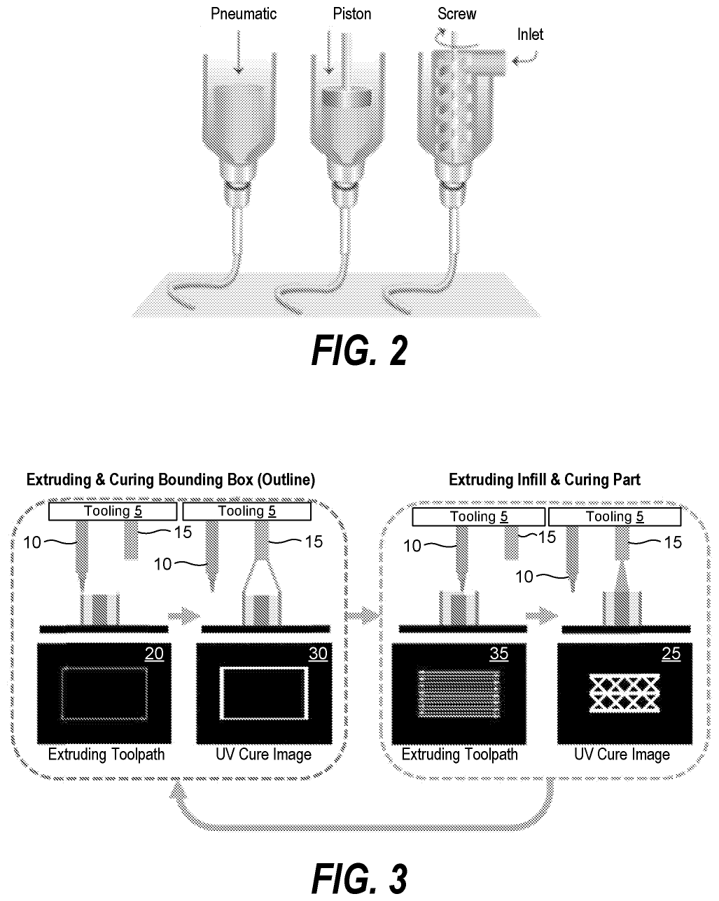

To process resin materials with higher viscosity, researchers often turn to Direct Ink Write, a material extrusion AM technology in which a viscous ink, often at room temperature, is selectively extruded through a translating nozzle to selectively deposit material. Materials used in DIW must possess a rheology to flow through the nozzle and cure kinetics to solidify upon deposition to keep their shape. As a result of these broad constraints, DIW is capable of processing a wide range of materials, especially high-viscosity materials with appropriate shear-thinning behavior. As shown in FIG. 2, high-viscosity material is extruded through the nozzle using the force applied by pneumatic-, piston-, or screw-driven methods. Unlike VP systems, DIW's applied shear stress is applied to the raw material and not imparted onto the previously printed layers, thus there is minimal risk in deforming the part during printing. Various ink solidification methods include solvent evaporation, gelation, or the ink possessing a yield stress.

Ultraviolet-Assisted Direct Ink Write (UV-DIW) is one subset of DIW where liquid photopolymers are extruded and then exposed to UV irradiation to solidify the ink's as-extruded shape. While versatile, production of parts using DIW poses multiple challenges. The rheology of the ink has to be tailored to be flowable through a small orifice, but upon deposition, not allow a bead to spread an excessive amount and lose its as-deposited shape. Shear-thinning behavior of the inks is fundamental to achieving this goal. A shear-thinning of viscosity of an ink decreases under the high shear rates present in the nozzle which facilitates flow through small nozzles at moderate pressures. Upon deposition, high shear rates are removed, and the viscosity of the ink increases, helping retain the as-deposited shape. Often, to achieve the desired shear-thinning behavior, fillers or rheology modifiers are added, affecting the composition of the final part.

A notable obstacle of DIW processing is that the minimum resolution of the printed features is limited by nozzle diameter and rheology of the material. Printing high-resolution features are a challenge due to the practical limitations of producing extremely small diameter nozzles and the tradeoff in increased printing time due to smaller nozzles having lower deposition rates. Additionally, to print microscale features (nozzle diameter=0.5-5.0 μm), the rheology of inks has to be carefully tailored. Tailoring inks to get the necessary rheological properties to print microscale features severely limits the possible formulations and materials. In addition, printing with small diameter nozzles and higher viscosity inks requires impractically large pressures, and functional inks containing solid particles will clog small nozzle diameters.

A further limitation of DIW is that, like other extrusion-based processes, there is a time lag between applying extrusion pressure to achieve steady-state extrusion and stopping extrusion pressure to achieve cessation of material flow. This lag produces either a thinned or bulged bead at the starting and stopping points; these errors will propagate over layers and result in reduced build quality. While dwelling the translation of the extruder at the start and stop reduces bead in-homogeneity, the problem persists and as a result DIW struggles to produce parts that require frequent starting and stopping (e.g., point-like depositions found in lattice structures). In addition, sharp transitions in printhead motion direction (e.g., when turning a corner of a layer) can result in print inaccuracies since the extrudate deposition speed cannot adequately match the instantaneous zeroing of the print-head's directional velocity. As a result, DIW parts often feature rounded corners and slight over-extrusion along contours from the serpentine toolpath rastering.

### Hybrid VP+DIW Process.

While vat photopolymerization excels at printing high-resolution features and sharp corners, it is limited to low-viscosity photoresins. Conversely, Direct Ink Write is capable of processing extremely high-viscosity photoresins, but is limited in printing high-resolution and sharp-cornered features. To enable printing of high-resolution and sharp-cornered features from high-viscosity photoresins, various embodiments are described for an additive manufacturing process that integrates both VP and DIW printing modalities.

According to various embodiments, a DIW system is described that may be employed to deposit, but not directly pattern, a layer of high-viscosity photopolymer. The DIW system may include an integrated light source, such as a UV projector similar to those used in MP-VP. The light source may be used to selectively photocure a deposited layer of photoresin to produce a desired shape of each layer. This process may be repeated in a layer-wise fashion with the DIW system depositing each layer of photoresin and the VP system selectively photocuring each layer until the part is completed.

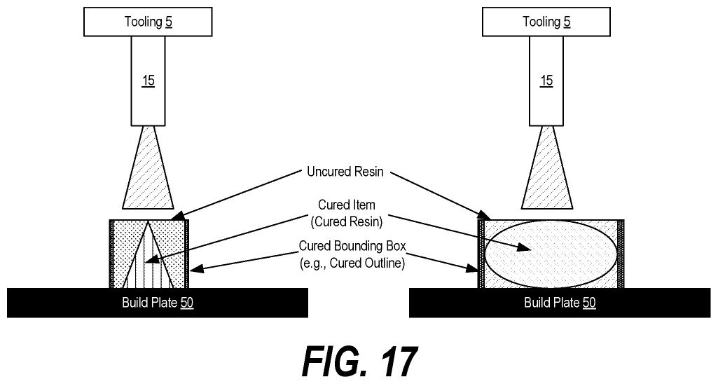

In some embodiments, a photocuring of each layer may be split into two processes. First, a rectangular bounding box, referred to as an “outline,” is extruded or otherwise deposited and photocured to create borders of a “vat” that contains uncured material of an infill. Then, additional resin may be extruded within the inside border of the cured vat and selectively cured via an applied dynamic mask of a projector or other light source. The process is shown in FIG. 17.

This process enables the printing of extremely high-viscosity photopolymers by integrating a DIW system to fill a printed vat, instead of using traditional recoating methods found in traditional VP machines. Using DIW to deposit each layer ensures that minimal shear stress is imparted onto the previously cured layers because the material actively flows from the nozzle instead of being spread by the shear stresses of a recoating blade. In addition, high-resolution features with sharp corners are produced by leveraging mask projection photocuring instead of directly patterning the material with DIW, which alleviates typical constrained relationships between material viscosity, orifice diameter, and printable feature size. By removing the viscosity constraints of traditional VP systems, the range of composition and material of photoresins is significantly broadened, including high performance, high molecular weight polymers, and highly loaded suspensions. In addition, the vat deposited by DIW only needs to be slightly larger than a printed part, effectively reducing the material within the printed vat as compared to traditional VP systems. Furthermore, the uncured, high-viscosity photoresin can support the subsequently printed layers, which eliminates the need for support structures.

The design and realization of the embodiments described herein are described in detail below. To demonstrate the capabilities of the process, and to validate its ability to process photocurable materials with viscosities greater than that which is printable on VP systems, and at resolutions greater than that which is achievable with DIW systems, three photoresins were printed, namely, an all-aromatic polyimide, a urethane acrylate elastomer, and an alumina photopolymer suspension. The all-aromatic polyimide includes a photocurable polyamic acid (PAA) photoresin with a zero-shear rate viscosity of 770 Pa·s. After printing, the green parts were thermally treated to convert the PAA to Poly(4,4′-oxidiphenylene pyromellitimide) (PMDA-ODA) polyimide (PI). The urethane acrylate elastomer includes a photoresin with a zero-shear rate viscosity of 21.7 Pa·s. To increase the stiffness of the elastomer, a variation of the photoresin was created by adding 5 wt % silica, resulting in a zero-shear rate viscosity of 38.6 Pa·s. The alumina photopolymer suspension includes a photoresin loaded with 85 wt % alumina that possessed a zero-shear rate viscosity of 1350 Pa·s. After printing, the green parts were thermally processed to remove the photopolymer binder and then sinter the alumina particles together. The breadth of the three inks' rheology (21.7-1350 Pa·s), composition (i.e., both neat and filled systems), and functionality (i.e., fully aromatic high performance polymer, elastomers, and ceramics) provides a suitable basis for validating the performance of the process. The resultant printed parts were then characterized to evaluate both their material properties and their dimensional fidelity, as will be described.

The embodiments described herein improve existing system by retaining their strengths in how they pattern material, pattern energy, and provide new material. By selectively patterning material via extrusion and thus, utilizing direct material addition instead of recoating, the viscosity constraint imposed by traditional VP processes is relaxed. By patterning energy to selectively cure the deposited material, the embodiments described herein greatly improve feature resolution of a UV-DIW process. Further, the embodiments described herein are able to support previously deposited material with a bed of material if the photoresin is sufficiently viscous. If the photoresin is not viscous enough, thin trusses of cured build material may be used for support as in traditional VP.

The hybrid processes described herein may be cyclical, repeating in a layer-by-layer fashion characteristic of additive manufacturing processes. Referring now to FIG. 3, to ensure each layer is level and homogenous, the printing of each layer may be categorized as follows. A tooling 5 may be provided having an extruder 10 and a light source 15. In some embodiments, the tooling 5 may be a single tooling or device having a single extruder 10 and a single light source 15. In some embodiments, the tooling 5 may be a single tooling or device having one or more extruders 10 and/or one or more light sources 15. In some embodiments, there may be multiple toolings 5 and, as such, a system may include one or more extruders 10 and/or one or more light sources 15.

First, referring to the left side of FIG. 3, a vat outline is extruded by an extruder 10 and cured using a light source 15 (e.g., a UV projector, UV DLP projector, and so forth). As such, a bounding box of a layer “outline” is extruded, where the extruding toolpath 20 for this process is shown in FIG. 3. The bounding box may be rectangular, although other shapes may be employed. The outline is then subsequently selectively cured using a light source, such as a UV projector. The outline as cured contains uncured resin infill that may be deposited in the second process to be described. For most materials, without the cured outline, the non-cured infill material will spread excessively and the print may fail. It is possible that, for some materials that exhibit yield-stress rheological behavior and are therefore sufficiently solid-like to prohibit spreading upon deposition, a cured outline may not be required, or the vat outline and the part layer can be simultaneously cured to enhance process efficiency. The vat outline may be sized just larger than the desired part, (e.g., a spacing of approximately ˜1 mm between the part and vat wall), which reduces the material needed for printing.

Second, referring to the right side of FIG. 3, the vat infill may be extruded by the extruder 10 and selective cured by the light source 15. To this end, an area contained by the outline bounding box, called the “infill,” may be extruded. After the infill is extruded or otherwise deposited, the process may be paused or halted to allow the uncured extruded photoresin to coalesce, permit the layer height to become even, and reduce the non-homogeneity of the discrete beads that result from extrusion. Last, the infill is selectively photocured by projecting a UV cure image 25 (e.g., a UV pattern), which may include an image of the layer. The UV cure image 25 of this process, may be different than that of the first process, where the UV cure image 30 of the first process is shown as having a rectangular shape.

In a case where an infill material has neither a sufficient viscosity to be extruded and cured without spreading excessively, nor sufficient structural integrity to contain the infill, a second extruder 10 with a more suitable material for forming the outline can be used. The process for each layer remains the same, with the second extruder 10 being used to form the outline. The second material does not necessarily have to be photocurable, as long as it retains its shape upon deposition to form the outline (e.g., a commercially available silicone).

The infill toolpath may comprise multiple parallel horizontal extrusions 40, as shown on the right side of FIG. 3. Through experimentation, it was determined that when an extruder 10 (or the tooling 5 thereof) reaches an end of a horizontal extrusion, it is ideal to stop extruding while continue translating in the same direction until the extruder 10 or nozzle thereof moves past the bounding box or outline. The combination of the extra horizontal movement and slight over-extrusion of the material produces a more homogenous infill. The extra movement carries the excess photoresin across the layer and it is then “wiped” by the outline. While over-extrusion in a normal DIW process would produce geometrically inaccurate parts, the over-extrusion present in the hybrid process produces more homogenous layers and has no effect on dimensions of the final item or part to be formed.

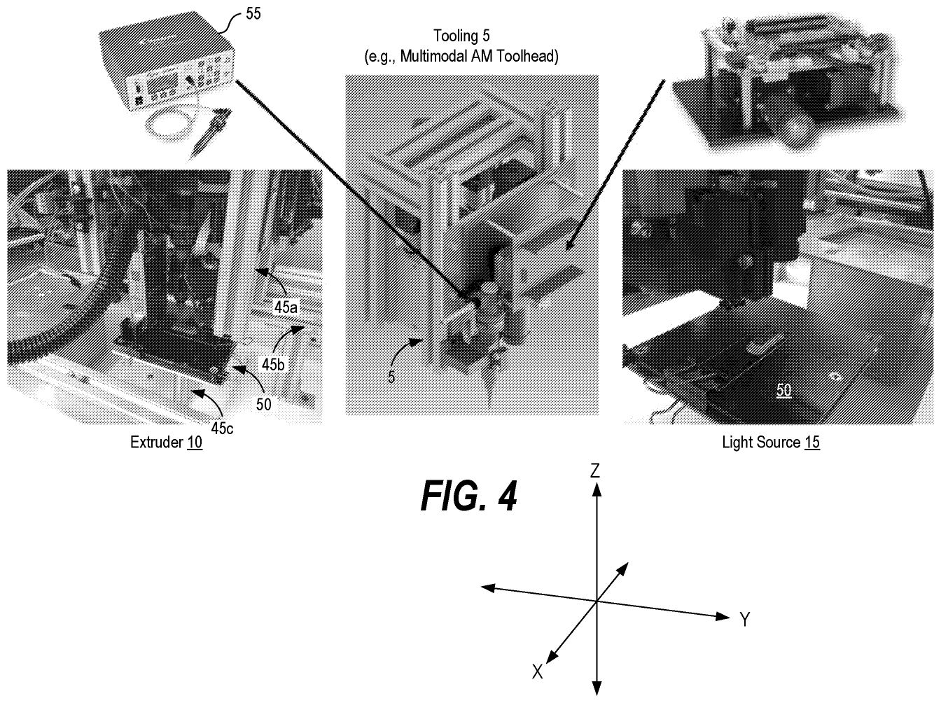

Referring now to FIG. 4, the system may be realized on a multimodal AM system that incorporates multiple AM technologies into a single platform. The system may include an extruder 10, such as a Nordson EFD Ultimus V precision dispenser or other suitable extruder 10, to extrude a high-viscosity photoresin, and a light source 15, such as a Keynote Photonics LC4500 UV projector (405 nm, 10 mW/cm2 intensity at the build plate), to selectively pattern ultraviolet irradiation. Both the extruder 10 and the light source 15 (e.g., projector) may be mounted on two linear slides 45 (e.g., Zaber A-LST linear slides) that provide travel in the X and Y direction. The travel is in the X and Y direction may include 500 mm or other desired range. The linear slides 45 may provide both the extruder 10 and the light source 15 freedom to position themselves at any position relative to a build plate 50, as needed. In various embodiments, a build plate 50 is translated in the Z direction with a third linear slide 45c (e.g., a Zaber A-LST linear slide) that provides 250 mm travel or other suitable range of travel. The pressure applied for extrusion may be controlled via a control box 55 (e.g., a Nordson EFD Ultimus V control box) that may be adjusted to alter a flow rate to match a translation speed of the extruder 10 and a nozzle diameter of a nozzle of the extruder 10. To ensure dimensionally accurate parts, UV curing of a layer may occur at a calibrated curing height. To achieve this, a build plate 50 may be moved in the Z direction between a calibrated curing height and a height of the extruder 10 while accounting for the addition of layers.

To realize processing high-viscosity photopolymers, the extruder 10 may first need to be capable of extruding a material. The extruder 10 may be pneumatically actuated. Thus, a maximum extrusion force may be limited by a maximum pneumatic pressure (2758 kPa/400 psi) the system can apply. As such, it is desired to reduce the pressure drop of the material through the nozzle of the extruder 10 and the extrusion pressure to increase the maximum viscosity the system is capable of processing. Initially, it was believed that since the nozzle of the extruder 10 is not directly patterning features, a large extrusion nozzle could be used. Increasing nozzle diameter significantly decreases the pressure required to produce a desired flow rate (Pressurex Viscosity/Diameter), thus larger nozzles increase the maximum possible photoresin viscosity. Unfortunately, a layer height is generally constrained to between 50% and 100% of the nozzle diameter. Ultimately, thin layers are desired for both producing high-resolution parts and ensuring adequate interlayer adhesion requiring the use of smaller diameter nozzles.

Since smaller diameter nozzles require significantly more extrusion pressure, alternative options may be explored to ensure the maximum possible viscosity range of photoresins was enabled. One option may include how a shape of the nozzle effects extrusion pressure. Two nozzle geometries are readily available, such as cylindrical and tapered cylindrical nozzles. Comparing these two geometries with both having the same exit diameter, tapered cylindrical nozzles require multiple orders of magnitude less pressure as cylindrical nozzles to achieve the same flow rates. Because of the lower pressures required for extrusion, only tapered nozzles were utilized. Another option may include processing highly viscous photoresins utilizing photoresins that exhibit shear-thinning behavior. Shear-thinning behavior is important to enabling extrusion through smaller nozzles at moderate pressures. If a photoresin is not extrudable within these constraints, various rheological modifiers can be added to increase the degree of shear thinning, and thus, increase the photoresins ability to be printed.

According to various embodiments, a flow rate from a nozzle of an extruder 10 must be adjusted to match a translation speed of the extruder 10 and a layer height. An incorrect flow rate may produce non-continuous beads or result in over extrusion, both resulting in low quality prints or failure. Using experimental rheology data, extrusion pressure, and nozzle geometry, a flow rate of the material may be determined using analytical models and a matched translation speed. As such, a flow rate and translation speed may be matched by adjusting either extrusion pressure or translation speed.

Analytical models may be leveraged to generate optimal parameters for the system. To improve printing throughput, higher extrusion flow rates and thus higher translation speed may be employed. However, these higher flow rates require higher extrusion pressures, creating a need to lower extrusion pressure via use of tapered cylindrical nozzles and photoresins with shear thinning behavior.

After deposition of a layer is complete, the material may be cured to a depth matching or slightly exceeding the extruded layer thickness to produce strong and geometrically accurate parts. Cure depth increases with increased time of exposure to UV irradiation. A cure depth larger than the layer height produces overcure, creating a dimensionally inaccurate part, and a cure depth less than the layer height produces a weak part with little to no interlayer adhesion that may result in the part shifting during printing and failure. In traditional VP, the Jacob's Equation is used to relate cure depth (Ca) to exposure (Eₘₐₓ) (Eq. (1)).

$${C}_{d} = {D}_{P} ln ( \frac{{E}_{max}}{{E}_{C}} ) , \qquad ( eq . 1 )$$

where depth of penetration (Dp) and critical exposure (Ec) are intrinsic material properties. These properties can be experimentally determined by creating a “working curve” (based on eq. 1 above) for each photoresin by exposing it to UV irradiation for different amounts of time and measuring the resulting cure depth. The resultant working curve can then be used to calculate the exposure time required to create a cure depth that matches or slightly exceeds the layer height of the extruded photoresin.

A control application may include program instructions executable by a computing device (e.g., program instructions stored in memory and executable by a hardware processor) that coordinate timing mechanical movements of a build process. To start a three-dimensional printing process (referred to as a “print”), a user may interact with a client device (e.g., a personal computing, a laptop, a tablet, a smartphone, and so forth) to specify layer height, exposure time, and provides files containing images of layer slices and GCODE for extrusion to a Lab VIEW program. First, a three-dimensional CAD model of a part or other item may be virtually sliced into layers (at a desired layer thickness) and exported as black and white image files (Autodesk Netfabb). These layer slice images are passed to the light source 15 (e.g., a UV projection tool head) which are projected accordingly for curing each layer. A script (e.g., a Matlab script) may produce GCODE for an outline and infill extrusion toolpaths using a desired length and width of an outline, a width of a single extruded bead, an extrusion translation speed, and pauses at the starting and stopping of extrusion. Lastly, a script (e.g., a Matlab script) may produce a black and white bitmap (.bmp) image file, or other suitable image file, for curing an outline using the specified length and width of the outline. The display of the image files may be iterated as each layer is completed.

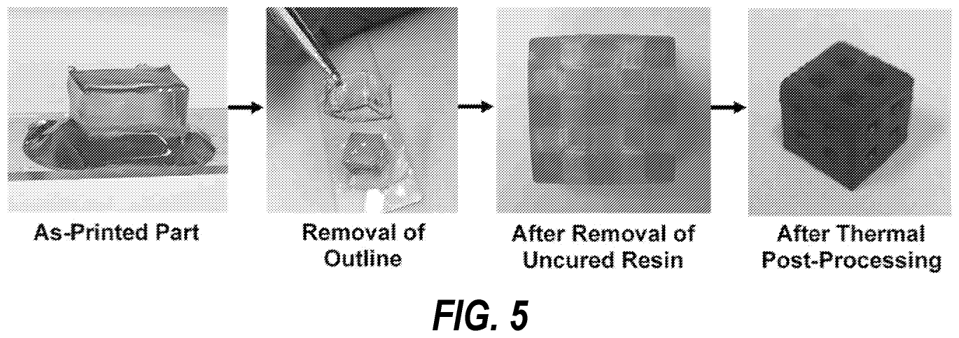

After a three-dimensional printing of an item is completed, the item may be removed from a printed vat filled with a viscous uncured photoresin. Un-cured photoresin may be removed by removing the part from the vat and rinsing with a mild solvent that removes any remaining residual photoresin. However, this may not be possible with extremely high-viscosity photoresins. When a print is finished, a manual photoresin removal method may be employed, similar to a de-powdering of powder-based AM parts, shown in FIG. 5.

First, the entire print build that contains the item may be removed from the build plate 50 and then the cured outline may be removed. The majority of the uncured excess photoresin surrounding the part may then be mechanically removed using a small spatula or similar instrument, which allows the photoresin to be reused in subsequent prints. The item may then be immersed in a mild solvent to dilute the remaining uncured photoresin and make it easier to remove with the use of a brush or compressed air, especially in small internal features. Further washing with solvent removes the last of the uncured photoresin. With the removal of all the excess photoresin, the part is either completed or ready for further post-processing, such as post-curing and thermal treatment.

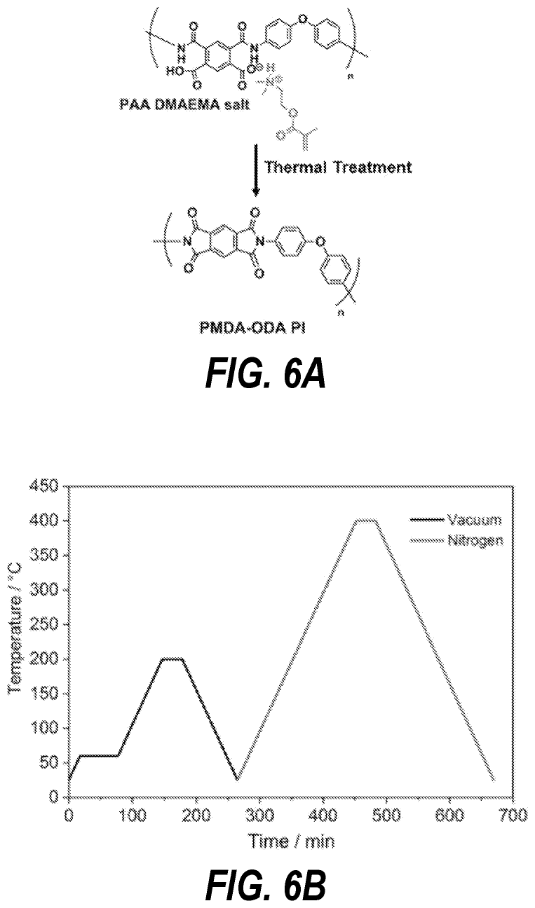

To demonstrate the ability of the system and methods described herein to print a wide range of photoresins, three materials with drastically different proper-ties were selected for validation studies: an all-aromatic polyimide, a urethane acrylate elastomer, and a photocurable ceramic suspension. All-aromatic polyimides (PI), commercially known as Kapton®, have degradation temperatures above 500° C., chemical and UV-irradiaton resistance, and a low dielectric constant making them suitable for extreme applications especially in electronics. However, due to having a nonexistent flow temperature and no solubility, all-aromatic polyimides present a paradox. The properties that make the material desirable have made AM of the material using traditional techniques elusive. Previous synthetic techniques relate to printing aromatic polyimides via UV-DIW, in which a UV-curable precursor (polyamic acid, PAA) photoresin is first printed and then thermally post-processed to remove solvent, pyrolize the crosslinks, and imidize the PAA into an all-aromatic polyimide (Poly (4,4′-oxidiphenylene pyromellitimide); PMDA-ODA) as shown in FIG. 6A. The photoresin comprises PAA dissolved in N-Methyl-2-pyrrolidone (NMP), forming a highly viscous liquid.

To make the photoresin photocurable, 2-(dimethylamino)ethyl meth-acrylate (DMAEMA) photocurable groups (0.5 equiv. per COOH) and TPO photoinitiator (2.5 wt %) may be added. A detailed description of the photoresin synthesis and post-print thermal treatment is shown in FIG. 6B. While prior techniques are capable of printing all-aromatic polyimide parts with various properties, the prior techniques prevented fabrication of high-resolution features and sharp corners. Therefore, the embodiments described herein may be employed to produce higher quality parts without sacrificing material properties provided by highly-viscous photoresins.

The majority of photopolymers currently printable by VP are low molecular weight oligomers that form highly crosslinked networks when cured, resulting in the materials being glassy, rigid, and brittle. While there has been a significant effort to create UV-curable elastomers in recent years, the materials exhibit either low elongations or low tensile strengths which results in low toughness. The embodiments described herein relax viscosity constraints of a photoresin, thus allowing the printing of new photocurable elastomer resins with high molecular weight monomers and novel chemistries, resulting in better material properties.

In various experiments performed in accordance with the embodiments described herein, Ebecryl® 242 aliphatic urethane acrylate oligomer photoresin may be employed. In addition to urethane acrylate, the photoresin contains 30 wt % isobornyl acrylate. 2.5 wt % Diphenyl(2,4,6-trimethylbenzoyl)phosphine oxide (TPO) was added to the photoresin to make it photosensitive. Owing to the high-viscosity of aliphatic urethane acrylates, similar material variations have been printed previously by heated-SLA and DIW. The addition of silica to urethanes acrylate photoresins at relatively low loadings increases the modulus of the material. To explore the effect of silica on the mechanical properties of Ebecryl® 242, 5 wt % fumed silica from Fiber Glast was added to the Ebecryl® 242 photoresin. Both the neat and 5 wt % silica urethane acrylate photoresin were printed and their mechanical properties tested using tensile testing. After removal of uncured photoresin, no further post-print processing was required.

Due to the difficulty in directly processing ceramics, complex ceramic geometries are often formed using colloidal processing. In the context of AM, VP is used to produce complex and high resolution green body geometries from photocurable colloidal suspensions. The resulting green body is then thermally treated to remove the photo-polymer binder and sinter the ceramic particles while retaining the as-printed 3D geometry. Unfortunately, the viscosity limitations of VP restrict the solids loading of the ceramic in the colloidal suspension. According to the Krieger-Dougherty equation, viscosity of the suspension increases rapidly as the volume fraction loading of ceramic particles increases, thus restricting the maximum loading of particles to keep the viscosity within the printable range. In limiting the amount of ceramic solids, there is a larger amount of photopolymer in the green part, which produces a higher amount of shrinkage during the debinding and sintering steps, increasing the likelihood of cracking. To balance printability and shrinkage, ceramic VP resins have a solid loading of at least 60 vol % and viscosity no more than 3 Pa·s at a shear rate of 10 s⁻¹ (shear rate during recoating step).

To achieve sufficient loading of ceramics, both reactive and non-reactive diluents, tuning of the particle size distribution, and heating of resin have been used to lower the viscosity. A maximum alumina volume loading of 53 vol % (80 wt %) in a VP photoresins was achieved by utilizing dispersants and heating of resin during printing, resulting in a linear shrinkage of 15% after sintering. The addition of diluents increases the amount of non-organic material in the green part, leading to an increased part shrinkage and higher chance of cracking. Additionally, the lower viscosity suspensions required for VP have higher rates of particle settling, which reduces the printing and storage times of the photoresin.

To demonstrate the capability of the hybrid AM process, and to explore its ability to process high-loaded photocurable resins, spherical alumina powder (a phase) with a D50 of 10±1.5 μm (Inframat Advanced Materials) was loaded at 85 wt % into commercial Makerjuice G+ photopolymer photoresin. The realized loading, 61.1 vol %, is slightly below the theoretical maximum packing fraction (63 vol %) of unimodal spherical particles. After printing, the part was thermally treated in air (via bottom loading Deltech box furnace) by ramping (2° C./min) and holding (100 min) the part at 200, 400, and 600° C. to slowly remove the binder, and then at 1650° C. for 2000 min to remove any residual binder and sinter the alumina particles.

To evaluate rheological behavior of each photoresin, steady-state flow sweeps and photorheology experiments may be conducted, for example, on a TA Instruments DHR-2 rheometer. Flow sweeps may be used to measure viscosity versus shear rate of each photoresin and were conducted using a 40 mm parallel plate geometry, a 500 μm gap, and a shear rate ranging from 0.1 to 100 s⁻¹. To evaluate photocuring behavior, specifically the gel time and the cured storage modulus, photorheology experiments were conducted with an Omnicure S2000 photo-accessory installed, 20 mm parallel plates, 0.1% oscillatory strain, and 1 Hz oscillation frequency. UV exposure was adjusted to 10 mW/cm2 to match the intensity of the UV projector used in the hybrid process and began 30 s into the test to allow the liquid photoresin sufficient time to equilibrate.

Thermogravimetric analysis (TGA) may be employed to quantify thermal stability of printed all-aromatic polyimide parts. TGA experiments may be performed on a TA Instruments Q500 from 20° C. to 800° C. at a rate of 10° C./min under a Nitrogen atmosphere, for example. To evaluate the mechanical properties of the printed parts, dynamic mechanical analysis (DMA) experiments in oscillatory tension and three point flexural setup may be performed with a TA Instruments Q800. Oscillatory tension measurements may be completed at 1 Hz, 0.15% strain, and the samples may be ramped from 25° C. to 400° C. at 3° C./min.

Tests may be completed on a rectangular sample approximately 5×10 mm. Three-point flexural tests may be performed at 0.5 mm/min on a fixture with a 15 mm gage length. The rectangular samples may be nominally 3×34×1 mm and the test may be based on the ASTM C1161 standard. Testing may be completed at both 25° C. and 400° C. to measure alumina flexural strength at both room and elevated temperatures, respectively. Additionally, tensile experiments may be completed on an Instron ElectoPuls E1000 equipped with a 250 N load cell and mechanical wedge grips. ASTM D638 Type V tensile samples scaled to 3×37×1 mm with a gage length of approximately 6.6 mm were printed and tested. Scanning electron microscopy (SEM) photos may be used to image an XZ cross-section of the parts. Images were taken using a LEO (Zeiss) 1550 Field Emission SEM. Samples were freeze fractured in LN2 and sputter coated using a Cressington 208HR Sputter Coater.

To quantify the resolution gained by using a VP system to selectively cure each layer, versus directly patterning the features via DIW, a feature size resolution test part was designed and fabricated with the urethane acrylate and highly loaded ceramic resins. ImageJ software from the National Institute of Health may be employed to measure the feature size of the parts with a ruler included in the image as a calibration scale.

To demonstrate the ability of the hybrid system, parts were printed from three high-performance photoresins that feature viscosities that precluded their processing via traditional VP: (i) an all-aromatic polyimde high-temperature engineering polymer (770 Pa·s), (ii) a urethane acrylate elastomer (neat: 21.7 Pa·s, filled with 5 wt % silica: 38.6 Pa·s); (iii) a 85 wt % alumina photopolymer suspension (1350 Pa·s).

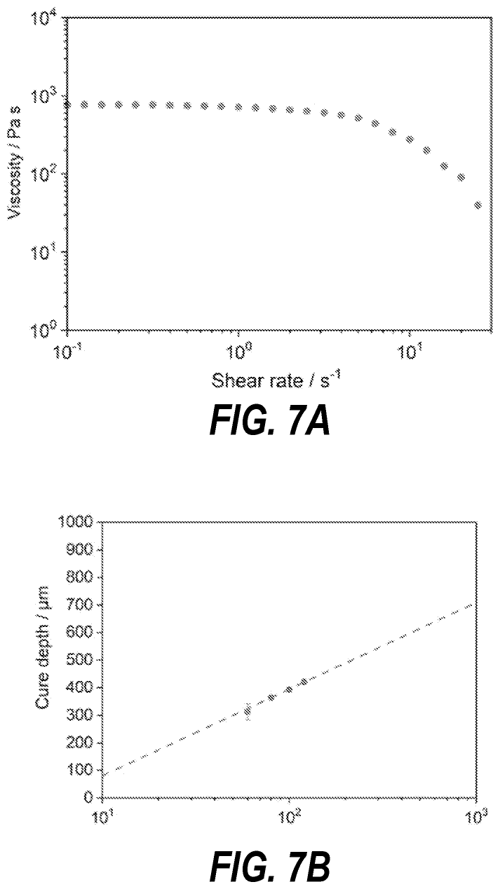

As shown in FIG. 7A, the UV-curable PAA photoresin had a measured zero-shear rate viscosity of 770 Pa·s and exhibited shear thinning behavior at moderate shear rates, 5 s⁻¹. The extruder 10 was able to extrude the photoresin through 250 μm diameter nozzle at a moderate pressure of 362 kPa. The working curve created for the photoresin is shown in FIG. 7B. The photoresin possessed a DP=153.16 μm and EC=7.67 mJ/cm². Thus, the curing time used in printing (8 s) was selected so that the thickness of the cured layer slightly exceeded the thickness of the extruded layer (150 μm) while preserving the desired feature size. Photorheology elucidated that the resin had a short gel time of 3.1 s and a sufficient cured storage modulus (G′>105 Pa) that made it suitable for printing.

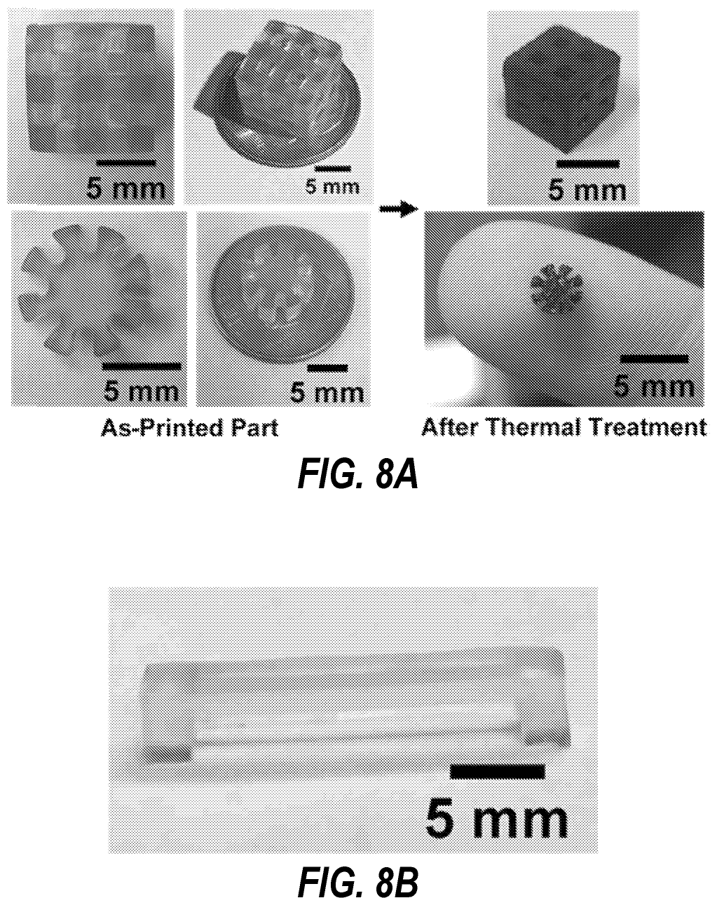

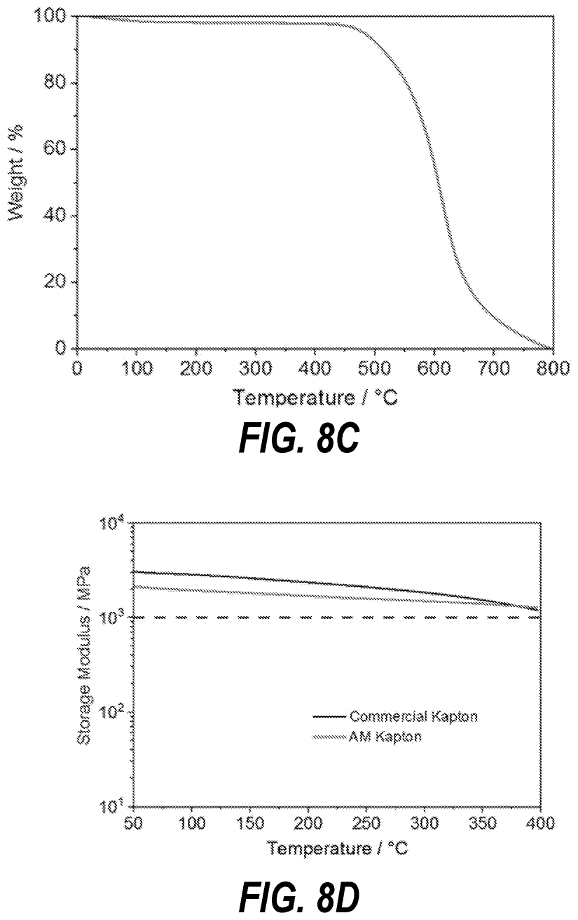

Various printed geometries featuring sharp corners were fabricated with the viscous PAA photoresin to demonstrate the hybrid system's ability to create geometries not possible with conventional DIW. After printing, the parts were removed from the uncured photoresin to reveal the as-printed shape of the part, shown in FIG. 8A. Notably, the parts exhibited sharp corners and high-resolution features that were impossible to achieve previously using DIW due to the cylindrical shape and size of the nozzle. The width of the thinnest portion of the star, shown in the bottom of FIG. 8A, averaged 1.00 mm, and the size of the internal channels of the 3D cube, shown at the top of FIG. 8A, averaged 1.62×1.50 mm. The highly viscous photoresin entrapped in the printed vat was capable of supporting large over-hanging features without a need for support material. A bridging feature 22 mm long was successfully printed with no supporting structure, shown in FIG. 8B.

After printing, excess photoresin was manually removed from the as-printed parts, which were then washed in solvent (N-Methyl-2-Pyrroli-done) and dried to completely remove any uncured photoresin, The parts were then thermally treated using the process described in FIG. 5 to remove solvent, pyrolize the crosslinks, and imidize the PAA to produce the final all-aromatic polyimide parts, shown in FIG. 8A. Thermal treatment linearly shrunk the parts isotropically ˜46% from their as-printed size, matching the shrinkage previously observed with conventional DIW printing, further increasing the feature resolution of the parts of FIG. 8A. The material retained its mechanical properties at high temperatures with DMA showing storage modulus remaining above 1 GPa up to 400° C., shown in FIG. 8D. The thermal stability of the printed material is comparable to that of the commercially available Kapton® film, shown in FIG. 8D. Thermogravimetric analysis (TGA) showed the printed all-aromatic polyimide also possessed a degradation temperature, Td,5%=534° C., shown in FIG. 8C.

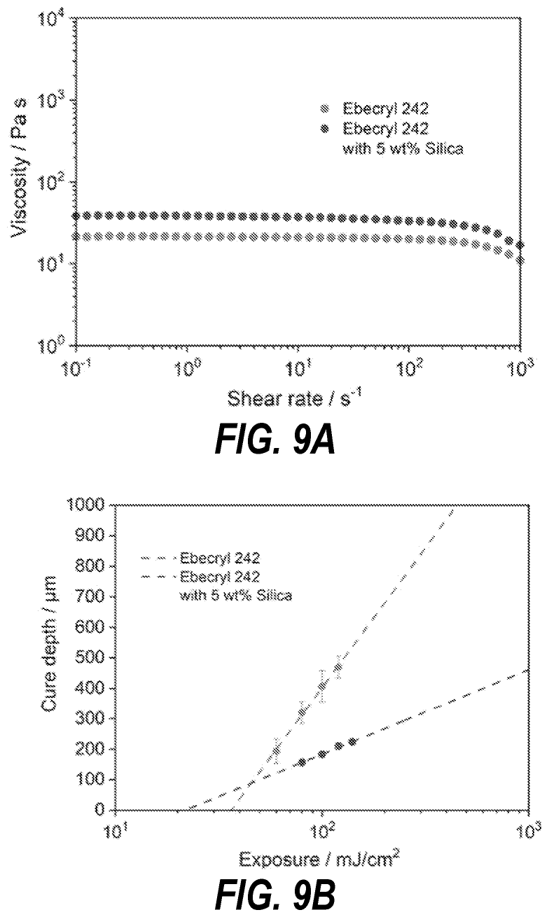

The neat urethane acrylate elastomer photoresin had a measured zero-shear rate viscosity of 21.7 Pa·s and exhibited the onset of shear thinning behavior at a shear rate of approximately 100 s⁻¹, shown in FIG. 9A. The photoresin containing 5 wt % silica had a higher zero-shear rate viscosity of 38.6 Pa·s and also exhibited shear thinning behavior, also shown in FIG. 9A. While both formulations demonstrated minimal shear thinning behavior, the extruder 10 was able to extrude them through a 250 μm diameter nozzle at moderate pressures (44.8 and 62.1 kPa respectively) due to the lower zero-shear viscosities.

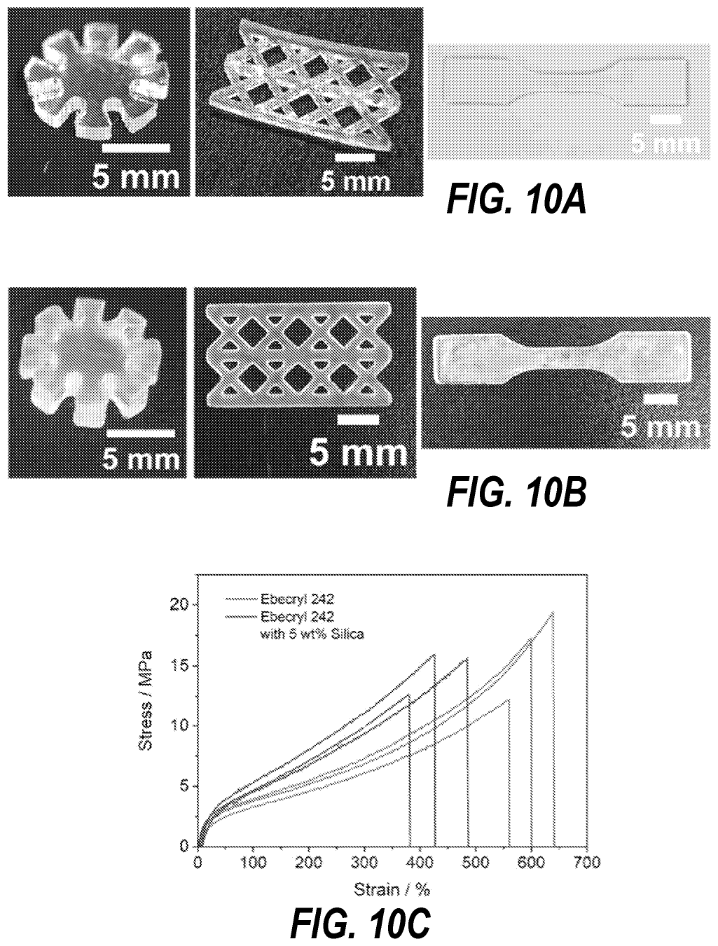

The working curves created for both urethane photoresins are shown in FIG. 10b. The neat photoresin possessed a DP=400.2 μm and EC=36.6 mJ/cm2, while the photoresin with 5 wt % silica possessed a DP=122.2 μm and EC=22.1 mJ/cm2. The photoresin with 5 wt % silica has a lower DP than the neat resin, thus requiring higher exposure times (6.5 s versus 6 s) to cure to the same 200 μm depth with sufficient interlayer adhesion as the neat resin. This difference is due to the added silica causing scattering of the UV irradiation.

Photorheology elucidated that the neat urethane photoresin had a short gel time of 1.6 s and a sufficient cured storage modulus (G′>106 Pa) that made it suitable for printing. The urethane photoresin with 5 wt % silica had a similar gel time of 1.5 s and a cured storage modulus (G′>106 Pa) that also made it suitable for printing. As before, various prints of different geometries were conducted with both the neat urethane photoresin, shown in FIG. 10A, and the 5 wt % silica urethane photoresin, shown in FIG. 10B. The resultant parts were removed from the uncured photoresin to reveal their high resolution and sharp-cornered features.

The neat urethane photoresin resin was dispensed with a nozzle diameter of 250 μm and then selectively photocured. The printed star geometry had a 1.20 mm width at its thinnest portion, shown in FIG. 10A, and the latticed structure featured 1.02 mm wide trusses, also shown in FIG. 10A. When printed with the urethane photoresin containing 5 wt % silica and same nozzle geometry, the thinnest feature of the star geometry measured an average of 1.33 mm in width, shown in FIG. 10A, and the latticed structure had 1.00 mm wide trusses, shown in FIG. 10A, averaged 1.00 mm.

For the neat photoresin, the three printed tensile samples averaged an elongation at break of 599.3±32.4% and a tensile strength of 16.33±3.03 MPa, shown in FIG. 10B. The combination of a high elongation at break and tensile strength resulted in an average toughness of 45.36±8.1 MJ m⁻³. For the photoresin containing 5 wt % silica, the three printed tensile samples averaged an elongation at break of 430.2±42.8% and a tensile strength of 14.75±1.53 MPa. The resulting average toughness was 34.3±5.4 MJ m⁻³. As expected, the photoresin containing 5 wt % silica resulted in parts with a higher modulus than the neat photoresin, but at the expense of exhibiting a lower elongation at break, shown in FIG. 10C. Demonstrating the higher modulus, stress at 300% strain was 10.11 MPa for the filled photoresin versus 6.77 MPa of the unfilled photoresin. For comparison, current commercial photo-polymer elastomers such as Carbon3D's EPU 40 and Stratasys's TangoPlus have an advertised elongation at break of 250% and 220% and a tensile strength of 7.7 and 1.5 MPa respectively.

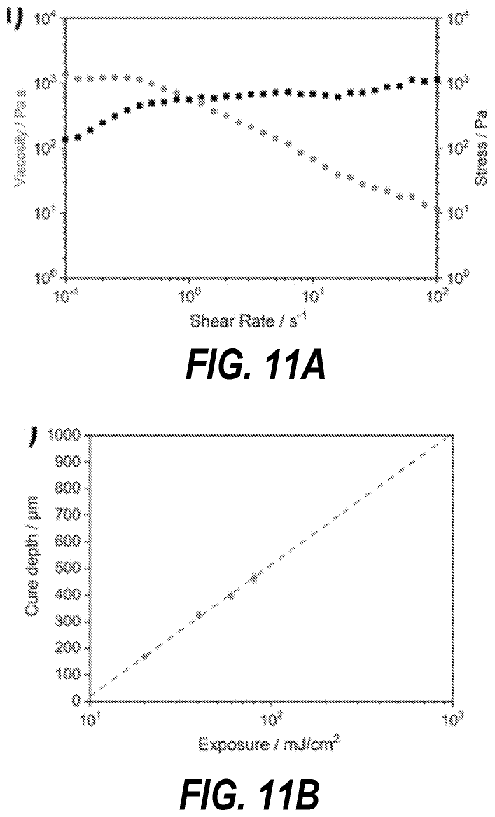

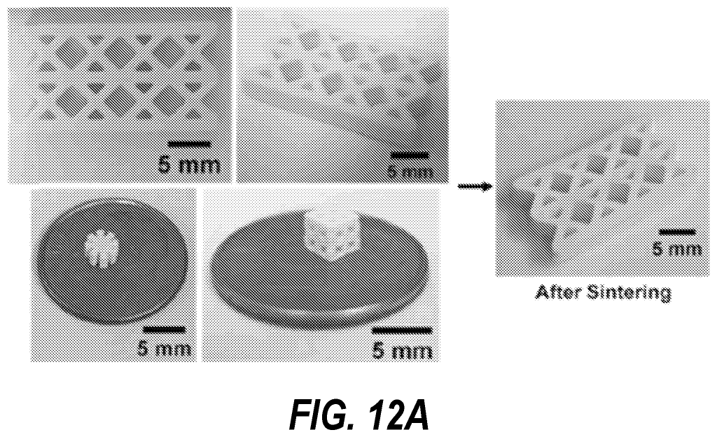

The highly loaded alumina photopolymer suspension exhibited a high zero-shear rate viscosity of 1350 Pa·s and a large degree of shear thinning behavior onset at ˜0.3 s⁻¹, shown in FIG. 11A. Due to the large degree of shear-thinning, the extruder 10 was able to extrude the photoresin through a 250 μm diameter nozzle at a moderate pressure of 172 kPa despite the high zero-shear rate viscosity. In addition to the high-viscosity, due to the high loading of ceramic particles, the photo-resin exhibits shear yield-stress behavior, shown in FIG. 11A. At a low shear rate (0.1 s⁻¹) the measured shear stress is ˜150 Pa, which is the critical yield stress that must be exceeded to initiate flow. The photoresin will behave solid-like (i.e., Storage>Loss Modulus) below this critical yield stress, which will occur once the material exits the extrusion nozzle.

The working curve for the material, shown in FIG. 11B, indicates that the resin's DP=211.2 μm and its EC=9.0 mJ/cm², thus demonstrating its ability to form sufficiently thick layers in reasonable exposure times even with the large volume of ceramic particles in the suspension. During printing, layer thickness of 150 μm with adequate interlayer adhesion was achieved with a 2 s exposure time with the instrument's UV light source. Photorheology elucidated that the photoresin had a short gel time of less than 1 s and a high cured storage modulus (G′>107 Pa) that made it suitable for printing.

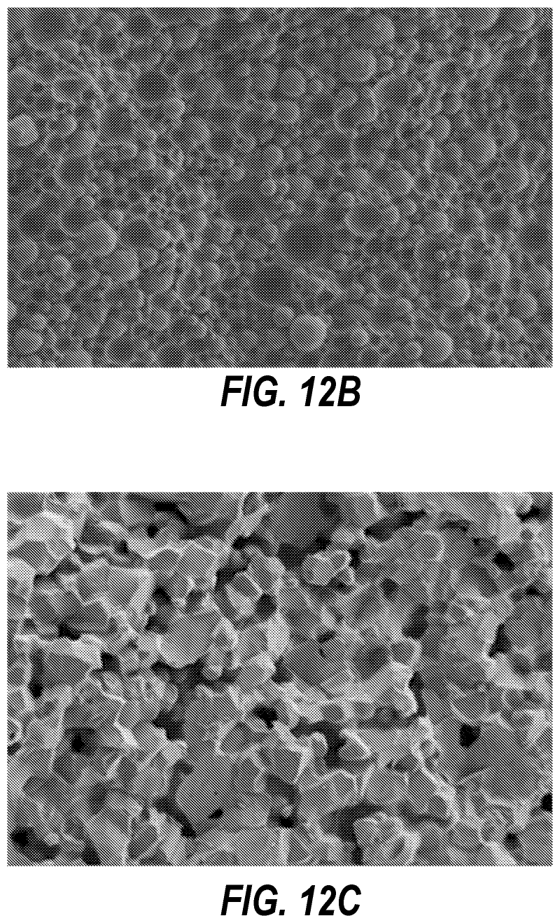

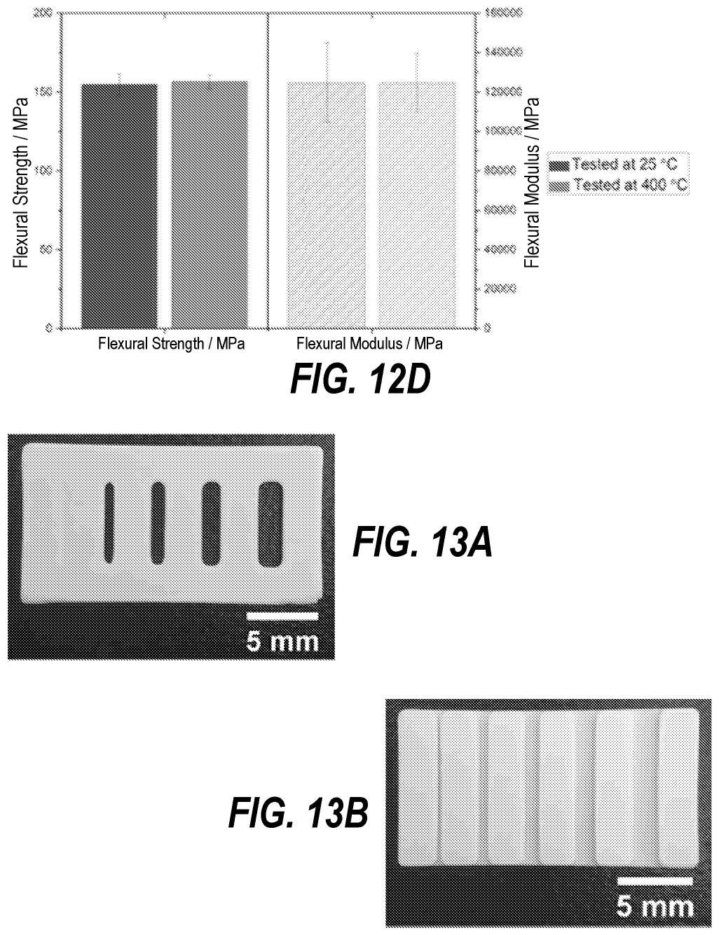

The alumina photopolymer suspension may be employed to print various geometries, shown in FIG. 12A. The width of the thinnest portion of the star shown in FIG. 12A averaged 0.56 mm, and the width of the 3D cube trusses shown in FIG. 12A was 0.48 mm, while the diameter of nozzle was 0.250 mm. SEM images of the green body showed the highly loaded suspension was effectively cured to create a green body with significant ceramic loading, shown in FIG. 12B. There is no evidence of any non-homogeneities such as the layer and extruded road interfaces, which are typical of traditional extrusion processes, shown in FIG. 12B. Since the photo-resins are not immediately cured after deposition, the layer has time to coalesce and homogenize.

After the post-process thermal treatment, a sintered alumina structure results FIG. 12A. Due to the removal of the photo-polymer binder and densification of the ceramic particles, an average isotropic linear shrinkage of 4.5% resulted; no evidence of cracking was observed. SEM images confirmed sintering of the particles; however, there was porosity in the sintered part, shown in FIG. 12C. The density of the sintered parts was 3.7 g/cm3 as measured with the Archimedes' Principle, less than the density of alumina (3.97 g/cm3). The parts' 93.2% theoretical density is comparable to alumina parts printed via VP that used vacuum during debinding, and higher than VP parts that did not use vacuum during thermal debinding. The use of smaller particles, use of a different sintering atmosphere, pressure, and/or temperatures may further increase the degree of densification.

To demonstrate the strength of the ceramic at elevated temperatures, the sintered three-point flexural specimens were tested at both 25 and 400° C., shown in FIG. 12D. The average flexural strength at 25° C. was 154.9±6.8 MPa, and at 400° C. was 156.6±4.2 MPa. The measured flexural strength was less than the expected strength of fully dense alumina, 320 MPa.

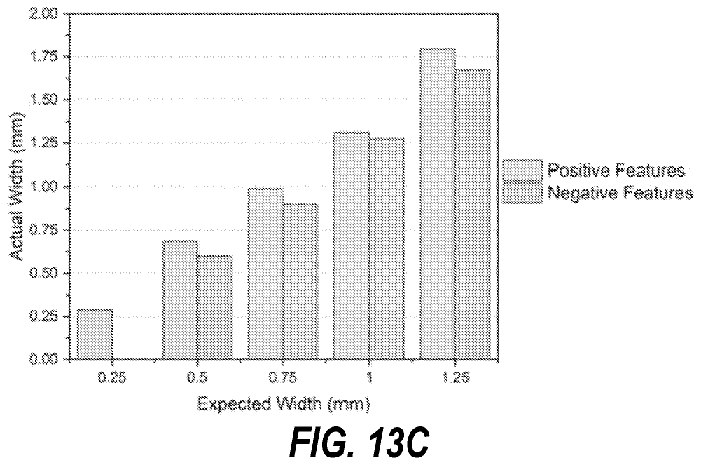

The embodiments described herein with successful in 3D printing a wide range of highly viscous materials with high resolution features and complex geometries. To quantify the resolution gained by using a VP system to selectively cure each layer using the hybrid approach, rectangular feature size resolution parts were printed. The test part consisted of negative rectangular features, shown in FIG. 13A, and positive rectangular features, shown in FIG. 13B, with increasing width of 0.25, 0.5, 0.75, 1.0, and 1.25 mm. Rectangular features were chosen to demonstrate the hybrid system's ability to realize sharp-cornered features. Additionally, a part printed via the embodiments described herein was directly compared to a part printed via DIW for the same material.

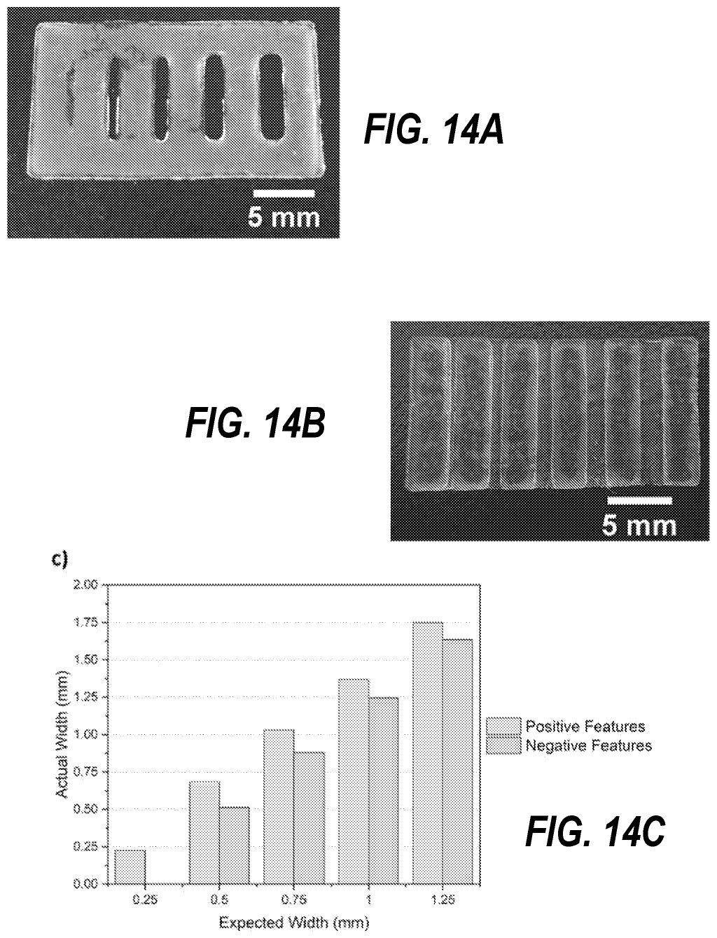

The parts were printed with both the 85 wt % alumina, shown in FIGS. 13A-C, and urethane acrylate with 5 wt % silica photoresin, shown in FIG. 14A-C. A feature size resolution part was not printed from all-aromatic polyimide photoresin due to time-sensitive solvent evaporation, which reduces the size of the part from its as-printed state, making the measurement of the feature size imprecise. The exposure time chosen for each material was based on the earlier working curve results to slightly exceed the extruded layer thickness. Alumina parts were printed with a 2 s exposure time and consisted of six 150 μm layers for the negative and eight 150 μm layers for the positive feature size resolution part. The urethane acrylate parts with 5 wt % silica were printed with a 6.5 s exposure time and consisted of five 200 μm layers for the negative and six 200 μm layers for the positive feature size part.

Both materials formed positive features as small as 0.25 mm and negative features as small as 0.5 mm. While there is visual evidence of the 0.25 mm negative feature, over-curing caused the gap to mostly close. The square corners exhibited slight rounding likely due to the light scattering caused by the particles within the suspension. At larger gap sizes, the features are larger than designed likely due to the projector being inaccurately calibrated. The urethane acrylate parts had a radii of positive feature corners of 0.30±0.01 mm and negative feature corners of 0.34±0.03 mm. The alumina parts had a radii of positive corner features of 0.41±0.02 mm and negative feature corners of 0.39±0.03 mm. Again, the slightly larger corners in the alumina parts is likely attributed to scattering of the UV irradiation by the particles.

The feature resolution in the Z direction is dictated by layer height, which is between 50% and 100% of the nozzle diameter. In these demonstrations, a 250 μm nozzle may be employed, so layer height theoretically could have been between 125 and 250 μm. The all-aromatic polyimide and alumina suspension photoresin produced parts with 150 μm layers, while the urethane acrylate elastomer photoresins produced parts with 200 μm layers. Further work could utilize smaller nozzles to produce smaller layers as required.

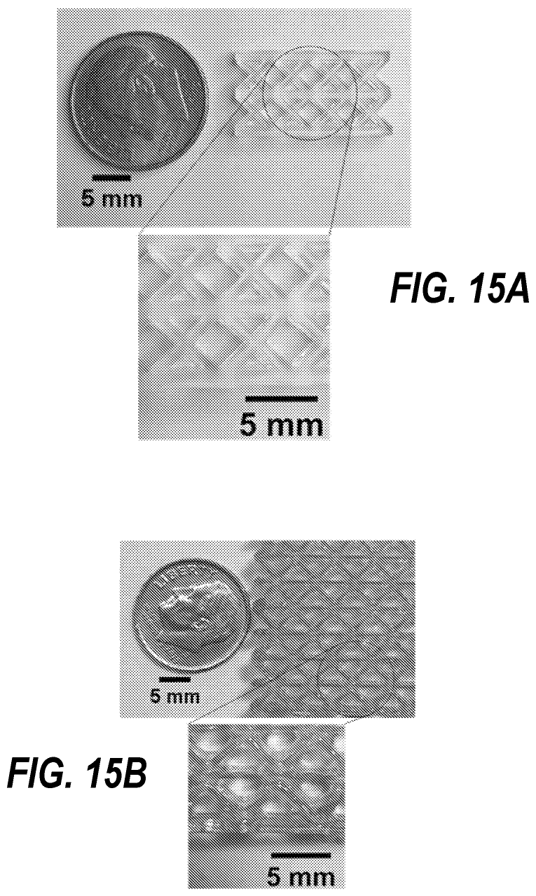

To provide a comparison between the sharp-cornered features created by the hybrid process and the rounded features created by DIW, the all-aromatic polyimide photoresin was printed using both traditional UV-DIW and the hybrid process. For sake of a fair comparison, a 250 μm nozzle and 150 μm layer height may be employed for both prints and a truss structure geometry was created, as shown in FIG. 15A. The DIW-produced part had clearly rounded corners and corners. The hybrid part meanwhile showed sharp corners, specifically the triangular and square features of the truss. The inner radii of triangular trusses for the VP+DIW hybrid part aver-aged 0.09±0.02 mm while the DIW part averaged a significantly larger radii of 0.63±0.06 mm, as shown in FIG. 15B. Additionally, the hybrid parts surface is homogenous with no evidence of the extrusion paths that the DIW part exhibits. The ends of the DIW truss are bulged and rounded due to the imperfect stopping and starting of the material extrusion, whereas the hybrid part has sharp and consistent corners.

The validation experiments confirmed that the hybrid process is capable of printing artifacts with high resolution features from highly viscous resins. While this system has great potential in enabling the printing of previously unprintable photoresins with high resolution features, it does have limitations. Drawbacks of the hybrid process include the increased difficulty of removing excess uncured photoresin, especially from small internal features, due to the resins' high-viscosity. By depositing each layer in a line-by-line fashion, instead of the whole layer at once like traditional recoating mechanisms, printing throughput is reduced. As in all AM processes, total printing time increases with part height, as recoating (extruding) each layer is the process bottleneck. Like other material extrusion processes (but unlike VP processes), the hybrid process's throughput is also dependent on a part's XY dimensions. However, unlike existing material extrusion AM processes, this bottleneck can be resolved by simply adding multiple DIW nozzles in parallel to increase the deposition width. The use of a DIW nozzle does constrain the layer thickness size; smaller nozzles provide smaller layer heights and improved Z-resolution, but at the expense of slower recoating and potentially additional rheological constraints. Addition-ally, for a successful print, the material used in the outline must have the rheological properties to retain its deposited shape in the time between deposition and curing. Otherwise, the extruded outline would spread excessively before being solidified and a part with substantial Z height would be impossible to achieve. The outline material must also have sufficient strength to contain the infill.

SEM images of XZ cross-sections, shown in FIGS. 12B and 12C, showed no evidence of any process-induced interfacial defects that are typical of material extrusion processes, such as layer and extruded road interfaces or voids. Since the photoresins are not immediately cured after deposition, the layer has time to coalesce and homogenize before photocuring.

In the present disclosure, a hybridized AM process featuring both VP and DIW printing modalities is demonstrated to enable additive manufacturing of high-resolution parts with high-viscosity photoresins. Traditional VP systems are limited to low-viscosity photoresins due to the recoating strategies used, which in turn limits the materials available for printing. By using a DIW system to deposit a flat, non-patterned layer of photopolymer and then using a VP system to selectively cure that layer, high-viscosity photoresins can be printed with high resolution.

With the hybrid VP+DIW system enabling the printing of photo-polymers with viscosities multiple orders of magnitude greater than what can now be currently used in traditional VP systems, high performance and high molecular weight materials with excellent material properties can now be successfully printed. This study demonstrated three such materials: an all-aromatic polyimide (770 Pa·s), a urethane acrylate elastomer (neat: 21.7 Pa·s, filled with 5 wt % silica: 38.6 Pa·s), and a highly loaded alumina photopolymer suspension (1350 Pa·s). The all aromatic polyimide parts showed excellent thermal stability, with a storage modulus above 1 GPa up to 400° C. and a Td,5%=534° C. The urethane acrylates elastomer parts showed excellent toughness, failing at an average elongation of 599% and an average stress of 16.3 MPa. A stiffer urethane acrylate was created by adding 5 wt % silica to the photoresin resulting an average elongation of 430.2%, and an average stress of 14.75 MPa. After sintering, the alumina parts experienced a linear shrinkage of only 4.5% from their green state and possessed a flexural strength at 25 and 400° C. of 154.9 and 156.6 MPa respectively.

The process demonstrated production of sharp-cornered features in the XY direction (0.5 mm in width for the system's current optics) as small as 250 μm and 150 μm in the Z direction. The two-step “outline” and “infill” strategy used to print each layer produces homogenous parts, free of discontinuous extrusion roads or layer interfaces. Furthermore, the uncured high-viscosity photoresin can support subsequently printed layers, eliminating the need for cured support structures.

In various embodiments, integration of another extruder 10 that deposits a material capable of forming a robust vat outline may be employed. By using another material to form the outline, the restrictions on the material properties for the infill can be furthered broadened, even allowing very low-viscosity photoresins to be used. Other embodiments may include an integration of additional extruders 10 to produce multi-material parts. To improve the speed of printing, additional nozzle shapes or an inclusion of multiple parallel extruders 10 may be employed. Lastly, printing photoresins that have desirable material properties of the final part but lack photoresin properties to be printable on traditional VP systems may be employed. These materials include other high molecular weight polymer-based photoresins and highly loaded suspensions and solutions.

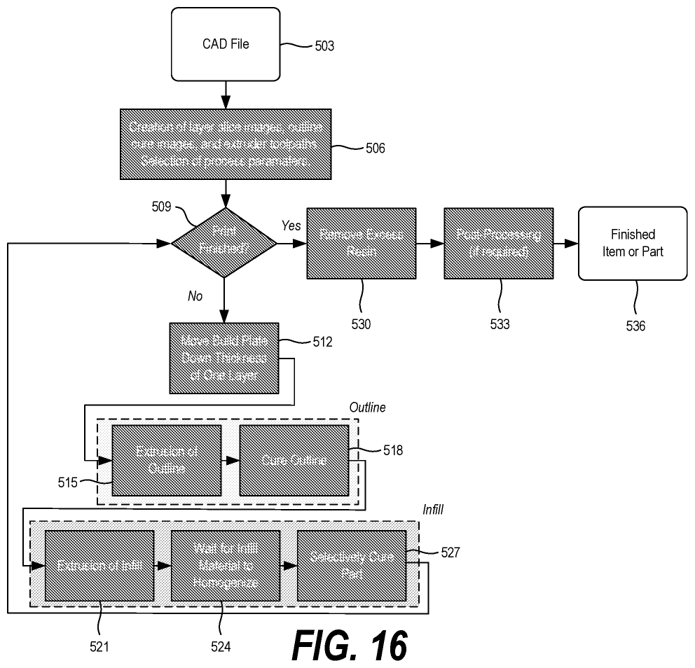

Referring next to FIG. 16, shown is a flowchart that provides one example of the operation of a portion of the system according to various embodiments. It is understood that the flowchart of FIG. 16 provides merely an example of the many different types of functional arrangements that may be employed to implement the operation of the portion of the system as described herein. As an alternative, the flowchart of FIG. 16 may be viewed as depicting an example of elements of a method implemented in a computing device (or processing circuitry) according to one or more embodiments.

First, tooling 5 may be provided that comprises one or more extruders 10 (e.g., at least one extruder 10) and one or more light sources 15 (e.g., at least one light source 15). The extruder 10 may include a nozzle and the light source 15 may include a UV projector, a UV DLP projector, and the like.

At box 503, a CAD file or other file suitable for printing a three-dimensional object may be provided to a printing application, service, engine, or other computing process. At box 506, layer slice images, outline cure image, extruder toolpaths may be generated. Additionally, at box 506, process parameters (e.g., thickness of layers, extrusion speed, etc.) may be selected.

At box 509, a determination may be made whether a print of an item has been completed. If the print has not completed, the process proceeds to box 512. At box 512, the build plate 50 may be moved or otherwise adjusted (e.g., down in the Z direction a height equal to a thickness of a layer). At box 515, a bounding box (or an outline) may be deposited or otherwise extruded on the build plate 50 via the extruder 10. At box 518, the bounding box (or the outline) may be cured using the light source 15.

Thereafter, at box 521, an additional amount of photoresin may be extruded or deposited as an infill (e.g., within the bounding box or outline). The system may pause to wait for the infill material to homogenize. At box 527, the infilled portion may be selective cured to product a layer of the item. In some embodiments, black and white bitmaps or other image files are generated in box 506 based on the CAD file (or other similar file). The printing process selectively iterates through the bitmaps or image files to produce light conforming to a shape of a layer. For instance, an image file may correspond to a layer of the item to be cured. In other words, the method includes generating black-and-white image files, each of the black-and-white image files corresponding to a layer of the item to be fabricated using the high-viscosity resin, and directing the light source 15 to project one of the black-and-white image files according to a current one of the layers being formed.

The process then reverts to box 509 and repeats until the printing of the item is finished. The process then proceed to box 530 where excess resin is removed, and box 533 where post-processing may be performed, if required, according to the examples provided above. Ultimately, at box 535, a finished item or part is generated having desirable properties.

The features, structures, or characteristics described above may be combined in one or more embodiments in any suitable manner, and the features discussed in the various embodiments are interchangeable, if possible. In the following description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims. If a component is described as having “one or more” of the component, it is understood that the component can be referred to as “at least one” component.

The terms “first,” “second,” etc. are used only as labels, rather than a limitation for a number of the objects. It is understood that if multiple components are shown, the components may be referred to as a “first” component, a “second” component, and so forth, to the extent applicable.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

The flowchart of FIG. 16 the functionality and operation of an implementation of portions of an application executed by processing circuitry or at least one hardware processor. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor (e.g., a hardware processor) in a computer system or other system. The machine code may be converted from the source code, etc. If embodied in hardware, each block may represent a circuit or a number of interconnected circuits to implement the specified logical function(s).

Although the flowchart of FIG. 16 shows a specific order of execution, it is understood that the order of execution may differ from that which is depicted. For example, the order of execution of two or more blocks may be scrambled relative to the order shown. Also, two or more blocks shown in succession in FIG. 16 may be executed concurrently or with partial concurrence. Further, in some embodiments, one or more of the blocks shown in FIG. 16 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that comprises software or code can be embodied in any non-transitory computer-readable medium for use by or in connection with an instruction execution system such as, for example, a processor in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims and clauses.

Clause 1. A method for fabricating an item using a high-viscosity photoresin, comprising: providing tooling that comprises an extruder and a light source; depositing, by the extruder of the tooling, a first non-patterned layer of the high-viscosity photoresin; selectively photocuring, by the light source of the tooling, the first non-patterned layer into a first predetermined layer shape; depositing, by the extruder of the tooling, a second non-patterned layer of the high-viscosity photoresin; and selectively photocuring, by the light source of the tooling, the second non-patterned layer into a second predetermined layer shape.

Clause 2. The method according to clause 1, wherein selectively photocuring the first non-patterned layer comprises: depositing the high-viscosity photoresin to form a bounding box, and photocuring the high-viscosity photoresin of the bounding box to create a vat having a cured border and having uncured material within the cured boarder; and depositing an additional amount of the high-viscosity photoresin within the cured border and selectively curing the additional amount of the high-viscosity photoresin using an applied dynamic mask of the light source.

Clause 3. The method according to any of clauses 1-2, wherein the bounding box is sized larger than a desired part such that a spacing of approximately 1 mm existing between the desired part and the bounding box.

Clause 4. The method according to any of clauses 1-3, wherein: the extruder is one of a plurality of extruders; the high-viscosity photoresin is one of a plurality of high-viscosity photoresins; and the bounding box is formed of a first type of the plurality of high-viscosity photoresins and the additional amount of the high-viscosity photoresin is a second type of the plurality of high-viscosity photoresins, the first type and the second type being different from one another.

Clause 5. The method according to any of clauses 1-4, wherein, after the additional amount of the high-viscosity photoresin is deposited within the cured border, and prior to the selectively curing of the additional amount, pausing to allow the additional amount of uncured extruded photoresin to coalesce, permit a layer height of the first non-patterned layer to become even, and reduce non-homogeneity of discrete beads.

Clause 6. The method according to any of clauses 1-5, further comprising: identifying a current layer of the item to be formed; and adjusting a dynamic mask of the light source using an image associated with the current layer, wherein selectively photocuring the viscosity photoresin using the dynamic mask as adjusted.

Clause 7. The method according to any of clauses 1-6, wherein depositing the additional amount of the high-viscosity photoresin within the cured border comprises: performing, by the extruder, multiple parallel horizontal extrusions, wherein, when the extruder reaches an end of a respective one of the horizontal extrusions, the depositing of the additional amount of the high-viscosity photoresin is stilled while the extruder continues to translate in a same direction until the extruder moves past the bounding box, thereby producing a homogenous infill.

Clause 8. The method according to any of clauses 1-7, further comprising adjusting a flow rate from a nozzle of the extruder to match a translation speed of the extruder and a layer height.

Clause 9. The method according to any of clauses 1-9, further comprising: generating a plurality of black-and-white image files, each of the black-and-white image files corresponding to a layer of the item to be fabricated using the high-viscosity resin; and directing the light source to project one of the black-and-white image files according to a current one of the layers being formed.

Clause 10. The method according to any of clauses 1-9, wherein the high-viscosity photoresin is one of an all-aromatic polyimide, a urethane acrylate elastomer, and an alumina photopolymer suspension.

Clause 11. A system for fabricating an item using a high-viscosity photoresin, comprising: a tool head comprising an extruder and a light source; program instructions stored in memory and executable by at least one hardware processor that, when executed, direct the at least one hardware processor to: deposit, by the extruder of the tooling, a first non-patterned layer of the high-viscosity photoresin; selectively photocure, by the light source of the tooling, the first non-patterned layer into a first predetermined layer shape; deposit, by the extruder of the tooling, a second non-patterned layer of the high-viscosity photoresin; and selectively photocure, by the light source of the tooling, the second non-patterned layer into a second predetermined layer shape.

Clause 12. The system according to clause 11, wherein selectively photocuring the first non-patterned layer comprises: depositing the high-viscosity photoresin to form a bounding box, and photocuring the high-viscosity photoresin of the bounding box to create a vat having a cured border and having uncured material within the cured boarder; and depositing an additional amount of the high-viscosity photoresin within the cured border and selectively curing the additional amount of the high-viscosity photoresin using an applied dynamic mask of the light source.

Clause 13. The system according to any of clauses 11-12, wherein the bounding box is sized larger than a desired part such that a spacing of approximately 1 mm existing between the desired part and the bounding box.

Clause 14. The system according to any of clauses 11-13, wherein: the extruder is one of a plurality of extruders; the high-viscosity photoresin is one of a plurality of high-viscosity photoresins; and the bounding box is formed of a first type of the plurality of high-viscosity photoresins and the additional amount of the high-viscosity photoresin is a second type of the plurality of high-viscosity photoresins, the first type and the second type being different from one another.

Clause 15. The system according to any of clauses 11-14, wherein, after the additional amount of the high-viscosity photoresin is deposited within the cured border, and prior to the selectively curing of the additional amount, the at least one hardware processor is further directed to: wait to allow the additional amount of uncured extruded photoresin to coalesce, permit a layer height of the first non-patterned layer to become even, and reduce non-homogeneity of discrete beads.

Clause 16. The system according to any of clauses 11-15, wherein the at least one hardware processor is further directed to: identify a current layer of the item to be formed; and adjust a dynamic mask of the light source using an image associated with the current layer, wherein selectively photocuring the viscosity photoresin using the dynamic mask as adjusted.

Clause 17. The system according to any of clauses 11-16, wherein depositing the additional amount of the high-viscosity photoresin within the cured border comprises: performing, by the extruder, multiple parallel horizontal extrusions, wherein, when the extruder reaches an end of a respective one of the horizontal extrusions, the depositing of the additional amount of the high-viscosity photoresin is stilled while the extruder continues to translate in a same direction until the extruder moves past the bounding box, thereby producing a homogenous infill.

Clause 18. The system according to any of clauses 11-17, wherein the at least one hardware processor is further directed to adjust a flow rate from a nozzle of the extruder to match a translation speed of the extruder and a layer height.

Clause 19. The system according to any of clauses 11-18, wherein the at least one hardware processor is further directed to: generate a plurality of black-and-white image files, each of the black-and-white image files corresponding to a layer of the item to be fabricated using the high-viscosity resin; and direct the light source to project one of the black-and-white image files according to a current one of the layers being formed.

Clause 20. The system according to any of clauses 11-19, wherein the high-viscosity photoresin is one of an all-aromatic polyimide, a urethane acrylate elastomer, and an alumina photopolymer suspension.

Therefore, the following is claimed:

1. A method for fabricating an item using a high-viscosity photoresin, comprising:
providing tooling that comprises an extruder and a light source;
depositing, by the extruder of the tooling, a first non-patterned layer of the high-viscosity photoresin;
selectively photocuring, by the light source of the tooling, the first non-patterned layer into a first predetermined layer shape;
depositing, by the extruder of the tooling, a second non-patterned layer of the high-viscosity photoresin; and
selectively photocuring, by the light source of the tooling, the second non-patterned layer into a second predetermined layer shape.

2. The method according to claim 1, wherein selectively photocuring the first non-patterned layer comprises:
depositing the high-viscosity photoresin to form a bounding box, and photocuring the high-viscosity photoresin of the bounding box to create a vat having a cured border and having uncured material within the cured boarder; and
depositing an additional amount of the high-viscosity photoresin within the cured border and selectively curing the additional amount of the high-viscosity photoresin using an applied dynamic mask of the light source.

3. The method according to claim 2, wherein the bounding box is sized larger than a desired part such that a spacing of approximately 1 mm existing between the desired part and the bounding box.

4. The method according to claim 2, wherein:
the extruder is one of a plurality of extruders;
the high-viscosity photoresin is one of a plurality of high-viscosity photoresins;
wherein the bounding box is formed of a first type of the plurality of high-viscosity photoresins and the additional amount of the high-viscosity photoresin is a second type of the plurality of high-viscosity photoresins, the first type and the second type being different from one another.

5. The method according to claim 2, wherein, after the additional amount of the high-viscosity photoresin is deposited within the cured border, and prior to the selectively curing of the additional amount, pausing to allow the additional amount of uncured extruded photoresin to coalesce, permit a layer height of the first non-patterned layer to become even, and reduce non-homogeneity of discrete beads.

6. The method according to claim 1, further comprising:
identifying a current layer of the item to be formed; and
adjusting a dynamic mask of the light source using an image associated with the current layer, wherein selectively photocuring the viscosity photoresin using the dynamic mask as adjusted.

7. The method according to claim 2, wherein depositing the additional amount of the high-viscosity photoresin within the cured border comprises:
performing, by the extruder, multiple parallel horizontal extrusions, wherein, when the extruder reaches an end of a respective one of the horizontal extrusions, the depositing of the additional amount of the high-viscosity photoresin is stilled while the extruder continues to translate in a same direction until the extruder moves past the bounding box, thereby producing a homogenous infill.

8. The method according to claim 1, further comprising adjusting a flow rate from a nozzle of the extruder to match a translation speed of the extruder and a layer height.

9. The method according to claim 1, further comprising:
generating a plurality of black-and-white image files, each of the black-and-white image files corresponding to a layer of the item to be fabricated using the high-viscosity resin; and
directing the light source to project one of the black-and-white image files according to a current one of the layers being formed.

10. The method according to claim 1, wherein the high-viscosity photoresin is one of an all-aromatic polyimide, a urethane acrylate elastomer, and an alumina photopolymer suspension.

11. A system for fabricating an item using a high-viscosity photoresin, comprising:
a tool head comprising an extruder and a light source;
program instructions stored in memory and executable by at least one hardware processor that, when executed, direct the at least one hardware processor to:
deposit, by the extruder of the tooling, a first non-patterned layer of the high-viscosity photoresin;
selectively photocure, by the light source of the tooling, the first non-patterned layer into a first predetermined layer shape;
deposit, by the extruder of the tooling, a second non-patterned layer of the high-viscosity photoresin; and
selectively photocure, by the light source of the tooling, the second non-patterned layer into a second predetermined layer shape.

12. The system according to claim 11, wherein selectively photocuring the first non-patterned layer comprises:
depositing the high-viscosity photoresin to form a bounding box, and photocuring the high-viscosity photoresin of the bounding box to create a vat having a cured border and having uncured material within the cured boarder; and
depositing an additional amount of the high-viscosity photoresin within the cured border and selectively curing the additional amount of the high-viscosity photoresin using an applied dynamic mask of the light source.

13. The system according to claim 12, wherein the bounding box is sized larger than a desired part such that a spacing of approximately 1 mm existing between the desired part and the bounding box.

14. The system according to claim 12, wherein:
the extruder is one of a plurality of extruders;
the high-viscosity photoresin is one of a plurality of high-viscosity photoresins;
wherein the bounding box is formed of a first type of the plurality of high-viscosity photoresins and the additional amount of the high-viscosity photoresin is a second type of the plurality of high-viscosity photoresins, the first type and the second type being different from one another.

15. The system according to claim 12, wherein, after the additional amount of the high-viscosity photoresin is deposited within the cured border, and prior to the selectively curing of the additional amount, the at least one hardware processor is further directed to:
wait to allow the additional amount of uncured extruded photoresin to coalesce, permit a layer height of the first non-patterned layer to become even, and reduce non-homogeneity of discrete beads.

16. The system according to claim 11, wherein the at least one hardware processor is further directed to:
identify a current layer of the item to be formed; and
adjust a dynamic mask of the light source using an image associated with the current layer, wherein selectively photocuring the viscosity photoresin using the dynamic mask as adjusted.

17. The system according to claim 12, wherein depositing the additional amount of the high-viscosity photoresin within the cured border comprises:
performing, by the extruder, multiple parallel horizontal extrusions, wherein, when the extruder reaches an end of a respective one of the horizontal extrusions, the depositing of the additional amount of the high-viscosity photoresin is stilled while the extruder continues to translate in a same direction until the extruder moves past the bounding box, thereby producing a homogenous infill.

18. The system according to claim 11, wherein the at least one hardware processor is further directed to adjust a flow rate from a nozzle of the extruder to match a translation speed of the extruder and a layer height.

19. The system according to claim 11, wherein the at least one hardware processor is further directed to:
generate a plurality of black-and-white image files, each of the black-and-white image files corresponding to a layer of the item to be fabricated using the high-viscosity resin; and
direct the light source to project one of the black-and-white image files according to a current one of the layers being formed.

20. The system according to claim 11, wherein the high-viscosity photoresin is one of an all-aromatic polyimide, a urethane acrylate elastomer, and an alumina photopolymer suspension.
